(19) United States
(12) Patent Application Publication
(10) Pub. No.: US 2012/0125100 A1
(43) Pub. Date: May 24, 2012

(54) VIBRATING GYROSCOPE INCLUDING PIEZOELECTRIC FILM

(75) Inventors: Ryuta Araki, Takarazuka-shi (JP); Takafumi Moriguchi, Nishinomiya-shi (JP); Takashi Ikeda, Kaizuka-shi (JP); Hiroshi Nishida, Takaishi-shi (JP); Yasuyuki Hirata, Takarazuka-shi (JP)

(73) Assignee: SUMITOMO PRECISION PRODUCTS CO, LTD., Amagasaki-shi, (JP)

(21) Appl. No.: 13/387,165

(22) PCT Filed: May 13, 2010
(86) PCT No.: PCT/JP2010/058096

§ 371 Date: Jan. 26, 2012

(30) Foreign Application Priority Data
Jul. 27, 2009 (JP) 2009-173972

(51) Int. Cl. G01C 19/56

(52) U.S. Cl. 73/504.12

(57) ABSTRACT

A vibrating gyroscope according to this invention includes a ring-shaped vibrating body 11 having a uniform plane, leg portions 15 flexibly supporting the ring-shaped vibrating body, a plurality of electrodes 13a, 13b, . . . , 13h that are disposed on the plane of or above the ring-shaped vibrating body and are formed with one of an upper-layer metallic film and a lower-layer metallic film, and a piezoelectric film being sandwiched between the upper-layer metallic film and the lower-layer metallic film in a thickness direction thereof. When one of the driving electrodes 13a for exciting a primary vibration of the ring-shaped vibrating body 11 in a vibration mode of cos Nθ is referred to as a reference driving electrode, the remaining plurality of electrodes 13b, . . . , 13h are disposed at specific positions. Such disposition allows this vibrating gyroscope to detect a secondary vibration inclusive of an out-of-plane vibration mode. A voltage for suppressing the secondary vibration is applied to a suppression electrode 13j.

### TECHNICAL FIELD

The present invention relates to a vibrating gyroscope including a piezoelectric film, in other words, a gyroscope utilizing vibrations, or an angular velocity sensor. More specifically, the present invention relates to a vibrating gyroscope that is capable of measuring variations in maximally triaxial angular velocity.

### BACKGROUND ART

In recent years, there have been intensely developed vibrating gyroscopes including a piezoelectric material, in other words, gyroscopes utilizing vibrations, or angular velocity sensors. Conventionally developed is a gyroscope including a vibrating body that itself is made of a piezoelectric material, as disclosed in Patent Document 1. There is also a gyroscope including a piezoelectric film that is formed on a vibrating body. For example, Patent Document 2 discloses a technique for, by using a PZT film as a piezoelectric material, exciting a primary vibration of a vibrating body as well as for detecting partial deformation of a gyroscope, which is caused by a coriolis force generated to the vibrating body when an angular velocity is applied to the vibrating body.

Reduction in size of a gyroscope itself is also an important issue because a wide variety of devices including gyroscopes have been quickly reduced in size. In order to realize the reduction in size of a gyroscope, significant improvement is required to accuracy in processing each member of the gyroscope. Desired in the industry will be not only simple size reduction but also further improvement in performance of a gyroscope, namely, in accuracy of detecting an angular velocity. However, the configuration of the gyroscope disclosed in Patent Document 2 fails to satisfy the demands over the last few years for reduction in size and improvement in performance.

In view of the above technical issues, the applicant of the present invention has proposed a technical idea of performing all the manufacturing steps basically as dry processes so as to realize high processing accuracy as well as to satisfy the demand for high performance as a vibrating gyroscope (Patent Document 3).

In addition to the above technical issues, expectations are being increased for a vibrating gyroscope that also measures an angular velocity of multi rotational axes (Patent Document 4, for example). Nevertheless, satisfactory development has not yet been made to a vibrating gyroscope that has a simple and useful configuration to realize reduction in size.
Patent Document 1: Japanese Unexamined Patent Publication No. H08-271258
Patent Document 2: Japanese Unexamined Patent Publication No. 2000-9473
Patent Document 3: Japanese Patent Application No. 2008-28835
Patent Document 4: Japanese Published Patent Publication No. 2005-529306
Patent Document 5: Japanese Published Patent Publication No. 2002-509615
Patent Document 6: Japanese Published Patent Publication No. 2002-510398

### DISCLOSURE OF THE INVENTION

### Problems to be Solved by the Invention

As described above, it is very difficult to achieve reduction in size and high processing accuracy in a vibrating gyroscope including a piezoelectric film as well as to satisfy the demand for improvement in performance of the gyroscope. A gyroscope of a small size generally has a defect that, upon application of an angular velocity to a vibrating body, weakened is a signal to be detected by a detection electrode of the gyroscope. Therefore, in such a small vibrating gyroscope, the difference is decreased between the signal to be essentially detected and a signal generated due to a sudden external impact (disturbance), which results in difficulty in improving detection accuracy as a gyroscope.

There are various types of external impacts that are received suddenly. For example, the vibrating body in a ring shape, which is disclosed in Patent Document 2 already referred to, receives an impact that causes seesaw-like motions, about a fixed post at the center of the ring serving as an axis thereof, in a direction perpendicular to a plane including the ring. This impact excites a vibration in what is called a rocking mode. There is another impact by which the entire periphery of a ring-shaped member of the vibrating body supported by the fixed post is simultaneously bent upward or downward from the plane including the ring. This impact excites a vibration in what is called a bounce mode. It is quite difficult to achieve a technique for accurately detecting an angular velocity even in cases where the vibrating gyroscope receives some of these impacts.

### Solutions to the Problems

The present invention solves the above technical problems to significantly contribute to reduction in size and improvement in performance of a vibrating gyroscope that includes a piezoelectric film and is capable of measuring an angular velocity of a single or multi rotational axes, in other words, a gyroscope utilizing vibrations, or an angular velocity sensor. The inventors initially worked on one of the above technical problems and adopted a vibrating gyroscope in a ring shape as a basic configuration, which is recognized as receiving a relatively small influence of a disturbance. The inventors then studied intensively to obtain a configuration for solving the respective technical problems by causing the piezoelectric film to excite a primary vibration as well as to detect a secondary vibration that is generated by a coriolis force. Found as a result is that accurate measurement of an angular velocity of a single rotational axis as well as an angular velocity of each of multi rotational axes is enabled by refining disposition of respective types of electrodes as well as electrical processing with use of the electrodes, even in a case with input causing an impact. Each of the electrodes of respective types causes the vibrating body to vibrate with use of the piezoelectric film or extracts, as a signal, deformation of the vibrating body with use of the piezoelectric film. Moreover, the inventors found out that, by devising the processing of an electrical signal related to the secondary vibration generated upon application of an angular velocity to the vibrating gyroscope, an S/N ratio is remarkably increased in comparison to the conventional cases, with no deterioration in responsiveness. The present invention was created in view of such a philosophy. It is noted that, in the present application, an “annular or polygonal vibrating gyroscope” is sometimes simply referred to as a “ring-shaped vibrating gyroscope”.

A vibrating gyroscope according to the present invention includes: a ring-shaped vibrating body having a uniform plane; leg portions flexibly supporting the ring-shaped vibrating body; a plurality of electrodes disposed on the plane of or above the ring-shaped vibrating body, and formed with at least one of an upper-layer metallic film and a lower-layer metallic film; and a piezoelectric film being sandwiched between the upper-layer metallic film and the lower-layer metallic film in a thickness direction thereof. Further, the plurality of electrodes include
(1) when N is a natural number of 2 or more, driving electrodes for exciting a primary vibration of the ring-shaped vibrating body in a vibration mode of cos Nθ, the driving electrodes being disposed (360/N)° apart from each other in a circumferential direction,
(2) detection electrodes for detecting a secondary vibration in a vibration mode of cos(N+1)θ generated when an angular velocity is applied to the ring-shaped vibrating body, and, when one of the driving electrodes is referred to as a reference driving electrode and S is equal to 0, 1, . . . , N, the detection electrodes being disposed at least any of [{360/(N+1)}×S]° apart from the reference driving electrode and [{360/(N+1)}×{S+(½)}]° apart from the reference driving electrode, and
(3) suppression electrodes for suppressing the secondary vibration in accordance with signals outputted from the detection electrodes, the suppression electrodes being disposed at least any of [{360/(N+1)}×S]° apart from the reference driving electrode and [{360/(N+1)}×{S+(½)}]° apart from the reference driving electrode.

Moreover, the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge, and the detection electrodes and the suppression electrodes are each disposed on a second electrode disposition portion and are not electrically connected to any one of the driving electrodes.

In this vibrating gyroscope, since a piezoelectric element is formed as an electrode in the specific region described above on the plane of the ring-shaped vibrating body, the vibrating gyroscope functions as a uniaxial angular velocity sensor and is capable of exciting the primary vibration as well as detecting the secondary vibration. In other words, this vibrating gyroscope is configured to excite the primary vibration in a plane identical with the plane (an X-Y plane, for example) including the piezoelectric element on the ring-shaped vibrating body (hereinafter, also referred to as in plane) as well as to control the motions of the ring-shaped vibrating body, with no piezoelectric element being formed on a side surface of the ring-shaped vibrating body. As a result, it is possible to fabricate the electrodes and the ring-shaped vibrating body with a high degree of accuracy in accordance with the dry process technique. Further, it is recognized as significantly advantageous that this vibrating gyroscope is capable of detecting a uniaxial (the X axis, for example) angular velocity by adopting a vibration mode not in the plane including the piezoelectric element (hereinafter, also referred to as an out-of-plane vibration mode). Several examples of the vibration mode of cos Nθ are disclosed, for example, in Patent Documents 4 to 6 cited above or in Japanese Patent Application No. 2007-209014 that was filed by the applicant of the present application. The term “flexible” is used to mean “so as to allow the vibrating body to vibrate” in the entire invention of the present application. The present application also includes the expression “(angularly) apart from” an electrode as a reference, in order to recite the disposition of each electrode. The angle in this case refers to a value of an azimuth of each electrode, assuming that the reference electrode has an azimuth equal to zero degree. The azimuth of each electrode can be set as an azimuth of a linear line from an arbitrary point defined at the center portion of the circumference or of the annular shape of the ring-shaped vibrating body (for example, in a case where the ring-shaped vibrating body has a circular shape, the center of the circle or the like; hereinafter, this center is referred to as a “reference point”) to the corresponding electrode. This linear line can be arbitrarily defined such as to pass through each electrode. This linear line can be typically defined so as to include the reference point as well as the graphic center, the center of gravity, or one of vertices of each electrode. For example, an electrode disposed 30° apart from a reference driving electrode is to be located such that the center of this electrode and the center of the reference driving electrode form an angle of 30° from the azimuth of the reference electrode. Unless otherwise specified, angles are recited in a manner that values of the angles increase clockwise. However, even with an assumption that the values of the angles increase counterclockwise, the angles recited in such a manner fall within the scope of the present invention as long as these angles satisfy the conditions defined herein.

A different vibrating gyroscope according to the present invention includes: a ring-shaped vibrating body having a uniform plane; leg portions flexibly supporting the ring-shaped vibrating body; a plurality of electrodes disposed on the plane of or above the ring-shaped vibrating body, and formed with at least one of an upper-layer metallic film and a lower-layer metallic film; and a piezoelectric film being sandwiched between the upper-layer metallic film and the lower-layer metallic film in a thickness direction thereof. Further, the plurality of electrodes include
(1) when N is a natural number of 2 or more, driving electrodes for exciting a primary vibration of the ring-shaped vibrating body in a vibration mode of cos Nθ, the driving electrodes being disposed (360/N)° apart from each other in a circumferential direction,
(2) detection electrodes for detecting a secondary vibration in a vibration mode of cos(N+1)θ generated when an angular velocity is applied to the ring-shaped vibrating body, and, when one of the driving electrodes is referred to as a reference driving electrode and S is equal to 0, 1, . . . , N, the detection electrodes being disposed at least any of [{360/(N+1)}×{S+(¼)}]° apart from the reference driving electrode and [{360/(N+1)}×{S+(¾)}]° apart from the reference driving electrode, and
(3) suppression electrodes for suppressing the secondary vibration in accordance with signals outputted from the detection electrodes, the suppression electrodes being disposed at least any of [{360/(N+1)}×{S+(¼)}]° apart from the reference driving electrode and [{360/(N+1)}×{S+(¾)}]° apart from the reference driving electrode.

Moreover, the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge, and the detection electrodes and the suppression electrodes are each disposed on a second electrode disposition portion and are not electrically connected to any one of the driving electrodes.

Also in this vibrating gyroscope, since a piezoelectric element is formed as an electrode in the specific region described above on the plane of the ring-shaped vibrating body, the vibrating gyroscope functions as a uniaxial angular velocity sensor and is capable of exciting the primary vibration as well as detecting the secondary vibration. In other words, this vibrating gyroscope is configured to excite the primary vibration in a plane identical with the plane (an X-Y plane, for example) including the piezoelectric element on the ring-shaped vibrating body as well as to control the motions of the ring-shaped vibrating body, with no piezoelectric element being formed on a side surface of the ring-shaped vibrating body. As a result, it is possible to fabricate the electrodes and the ring-shaped vibrating body with a high degree of accuracy in accordance with the dry process technique. Further, it is recognized as significantly advantageous that this vibrating gyroscope is capable of detecting a uniaxial (the Y axis, for example) angular velocity by adopting an out-of-plane vibration mode.

A different vibrating gyroscope according to the present invention includes: a ring-shaped vibrating body having a uniform plane; leg portions flexibly supporting the ring-shaped vibrating body; a plurality of electrodes disposed on the plane of or above the ring-shaped vibrating body, and formed with at least one of an upper-layer metallic film and a lower-layer metallic film; and a piezoelectric film being sandwiched between the upper-layer metallic film and the lower-layer metallic film in a thickness direction thereof. Further, the plurality of electrodes include
(1) when N is a natural number of 3 or more, driving electrodes for exciting a primary vibration of the ring-shaped vibrating body in a vibration mode of cos Nθ, the driving electrodes being disposed (360/N)° apart from each other in a circumferential direction,
(2) detection electrodes for detecting a secondary vibration in a vibration mode of cos(N−1)θ generated when an angular velocity is applied to the ring-shaped vibrating body, and, when one of the driving electrodes is referred to as a reference driving electrode and S is equal to 0, 1, . . . , N−2, the detection electrodes being disposed at least any of [{360/(N−1)}×S]° apart from the reference driving electrode and [{360/(N−1)}×{S+(½)}]° apart from the reference driving electrode, and
(3) suppression electrodes for suppressing the secondary vibration in accordance with signals outputted from the detection electrodes, the suppression electrodes being disposed at least any of [{360/(N−1)}×S]° apart from the reference driving electrode and [{360/(N−1)}×{S+(½)}]° apart from the reference driving electrode.

Moreover, the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge, and the detection electrodes and the suppression electrodes are each disposed on a second electrode disposition portion and are not electrically connected to the first electrode disposition portion.

Also in this vibrating gyroscope, since a piezoelectric element is formed as an electrode in the specific region described above on the plane of the ring-shaped vibrating body, the vibrating gyroscope functions as a uniaxial angular velocity sensor and is capable of exciting the primary vibration as well as detecting the secondary vibration. In other words, this vibrating gyroscope is configured to excite the primary vibration in a plane identical with the plane (an X-Y plane, for example) including the piezoelectric element on the ring-shaped vibrating body as well as to control the motions of the ring-shaped vibrating body, with no piezoelectric element being formed on a side surface of the ring-shaped vibrating body. As a result, it is possible to fabricate the electrodes and the ring-shaped vibrating body with a high degree of accuracy in accordance with the dry process technique. Further, it is recognized as significantly advantageous that this vibrating gyroscope is capable of detecting a uniaxial (the X axis, for example) angular velocity by adopting an out-of-plane vibration mode.

A different vibrating gyroscope according to the present invention includes: a ring-shaped vibrating body having a uniform plane; leg portions flexibly supporting the ring-shaped vibrating body; a plurality of electrodes disposed on the plane of or above the ring-shaped vibrating body, and formed with at least one of an upper-layer metallic film and a lower-layer metallic film; and a piezoelectric film being sandwiched between the upper-layer metallic film and the lower-layer metallic film in a thickness direction thereof. The plurality of electrodes include
(1) when N is a natural number of 3 or more, driving electrodes for exciting a primary vibration of the ring-shaped vibrating body in a vibration mode of cos Nθ, the driving electrodes being disposed (360/N)° apart from each other in a circumferential direction,
(2) detection electrodes for detecting a secondary vibration in a vibration mode of cos(N−1)θ generated when an angular velocity is applied to the ring-shaped vibrating body, and, when one of the driving electrodes is referred to as a reference driving electrode and S is equal to 0, 1, . . . , N−2, the detection electrodes being disposed at least any of [{360/(N−1)}×{S+(¼)}]° apart from the reference driving electrode and [{360/(N−1)}×{S+(¾)}]° apart from the reference driving electrode, and
(3) suppression electrodes for suppressing the secondary vibration in accordance with signals outputted from the detection electrodes, the suppression electrodes being disposed at least any of [{360/(N−1)}×{S+(¼)}]° apart from the reference driving electrode and [{360/(N−1)}×{S+(¾)}]° apart from the reference driving electrode.

Moreover, the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge, and the detection electrodes and the suppression electrodes are each disposed on a second electrode disposition portion and are not electrically connected to the first electrode disposition portion.

Also in this vibrating gyroscope, since a piezoelectric element is formed as an electrode in the specific region described above on the plane of the ring-shaped vibrating body, the vibrating gyroscope functions as a uniaxial angular velocity sensor and is capable of exciting the primary vibration as well as detecting the secondary vibration. In other words, this vibrating gyroscope is configured to excite the primary vibration in a plane identical with the plane (an X-Y plane, for example) including the piezoelectric element on the ring-shaped vibrating body as well as to control the motions of the ring-shaped vibrating body, with no piezoelectric element being formed on a side surface of the ring-shaped vibrating body. As a result, it is possible to fabricate the electrodes and the ring-shaped vibrating body with a high degree of accuracy in accordance with the dry process technique. Further, it is recognized as significantly advantageous that this vibrating gyroscope is capable of detecting a uniaxial (the Y axis, for example) angular velocity by adopting an out-of-plane vibration mode.

A different vibrating gyroscope according to the present invention includes: a ring-shaped vibrating body having a uniform plane; leg portions flexibly supporting the ring-shaped vibrating body; a plurality of electrodes disposed on the plane of or above the ring-shaped vibrating body, and formed with at least one of an upper-layer metallic film and a lower-layer metallic film; and a piezoelectric film being sandwiched between the upper-layer metallic film and the lower-layer metallic film in a thickness direction thereof. The plurality of electrodes include
(1) when N is a natural number of 2 or more, driving electrodes for exciting a primary vibration of the ring-shaped vibrating body in a vibration mode of cos Nθ, the driving electrodes being disposed (360/N)° apart from each other in a circumferential direction,
(2) first detection electrodes for detecting a first secondary vibration in a vibration mode of cos(N+1)θ generated when an angular velocity is applied to the ring-shaped vibrating body, and, when one of the driving electrodes is referred to as a reference driving electrode and S is equal to 0, 1, . . . , N, the first detection electrodes being disposed at least any of [{360/(N+1)}×S]° apart from the reference driving electrode and [{360/(N+1)}×{S+(½)}]° apart from the reference driving electrode,
(3) second detection electrodes for detecting a second secondary vibration having a vibration axis {90/(N+1)}° apart from that of the first secondary vibration, the second detection electrodes being disposed at least any of [{360/(N+1)}×{S+(¼)}]° apart from the reference driving electrode and [{360/(N+1)}×{S+(¾)}]° apart from the reference driving electrode,
(4) first suppression electrodes for suppressing the first secondary vibration in accordance with signals outputted from the first detection electrodes, the first suppression electrodes being disposed at least any of [{360/(N+1)}×S]° apart from the reference driving electrode and [{360/(N+1)}×{S+(½)}]° apart from the reference driving electrode, and
(5) second suppression electrodes for suppressing the second secondary vibration in accordance with signals outputted from the second detection electrodes, the second suppression electrodes being disposed at least any of [{360/(N+1)}×{S+¼}]° apart from the reference driving electrode and [{360/(N+1)}×{S+(¾)}]° apart from the reference driving electrode.

Moreover, the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge, and the first detection electrodes, the second detection electrodes, the first suppression electrodes, and the second suppression electrodes are each disposed on a second electrode disposition portion and are not electrically connected to any one of the driving electrodes.

In this vibrating gyroscope, since a piezoelectric element is formed as an electrode in the specific region described above on the plane of the ring-shaped vibrating body, the vibrating gyroscope functions as a biaxial angular velocity sensor and is capable of exciting the primary vibration as well as detecting the secondary vibration. In other words, this vibrating gyroscope is configured to excite the primary vibration in a plane identical with the plane (an X-Y plane, for example) including the piezoelectric element on the ring-shaped vibrating body as well as to control the motions of the ring-shaped vibrating body, with no piezoelectric element being formed on a side surface of the ring-shaped vibrating body. As a result, it is possible to fabricate the electrodes and the ring-shaped vibrating body with a high degree of accuracy in accordance with the dry process technique. Further, it is recognized as significantly advantageous that this vibrating gyroscope is capable of detecting a biaxial (each of the X axis and the Y axis, for example) angular velocity by adopting an out-of-plane vibration mode.

In order to detect an angular velocity with respect to still another axis, when one of the driving electrodes is referred to as a reference driving electrode and S is equal to 0, 1, . . . , N, the detection electrodes, which detect a secondary vibration in a vibration mode of cos(N+1)θ generated when an angular velocity is applied to the ring-shaped vibrating body, and which are disposed at least any of [{360/(N+1)}×S]° apart from the reference driving electrode and [{360/(N+1)}×{S+(½)}]° apart from the reference driving electrode, are referred to as first detection electrodes. Further, the suppression electrodes, which are disposed at any angles detailed above, are referred to as first suppression electrodes, and the secondary vibration is referred to as the first secondary vibration. In this case, the plurality of electrodes further include the following (4), and the second detection electrodes and second suppression electrodes can be each disposed on the second electrode disposition portion:
(4) the second detection electrodes for detecting a second secondary vibration having a vibration axis {90/(N+1)}° apart from that of the first secondary vibration, the second detection electrodes being disposed at least any of [{360/(N+1)}×{S+(¼)}]° apart from the reference driving electrode and [{360/(N+1)}×{S+(¾)}]° apart from the reference driving electrode.

Similarly, in order to detect an angular velocity of a different axis, when one of the driving electrodes is referred to as a reference driving electrode and S is equal to 0, 1, . . . , N, the detection electrodes, which detect a secondary vibration in a vibration mode of cos(N+1)θ generated when an angular velocity is applied to the ring-shaped vibrating body, and which are disposed at least any of [{360/(N+1)}×{S+(¼)}]° apart from the reference driving electrode and [{360/(N+1)}×{S+(¾)}]° apart from the reference driving electrode, are referred to as second detection electrodes. Further, the suppression electrodes, which are disposed at any angles detailed above, are referred to as second suppression electrodes, and the secondary vibration is referred to as a second secondary vibration. In this case, the plurality of electrodes further include the following (4), and first detection electrodes and the first suppression electrodes can be each disposed on the second electrode disposition portion:
(4) the first detection electrodes for detecting a first secondary vibration having a vibration axis {90/(N+1)}° apart from that of the second secondary vibration, the first detection electrodes being disposed at least any of [{360/(N+1)}×S]° apart from the reference driving electrode and [{360/(N+1)}×{S+(½)}]° apart from the reference driving electrode.

A different vibrating gyroscope according to the present invention includes: a ring-shaped vibrating body having a uniform plane; leg portions flexibly supporting the ring-shaped vibrating body; a plurality of electrodes disposed on the plane of or above the ring-shaped vibrating body, and formed with at least one of an upper-layer metallic film and a lower-layer metallic film; and a piezoelectric film being sandwiched between the upper-layer metallic film and the lower-layer metallic film in a thickness direction thereof. The plurality of electrodes include
(1) when N is a natural number of 3 or more, driving electrodes for exciting a primary vibration of the ring-shaped vibrating body in a vibration mode of cos Nθ, the driving electrodes being disposed (360/N)° apart from each other in a circumferential direction,
(2) first detection electrodes for detecting a first secondary vibration in a vibration mode of cos(N−1)θ generated when an angular velocity is applied to the ring-shaped vibrating body, and, when one of the driving electrodes is referred to as a reference driving electrode and S is equal to 0, 1, . . . , N−2, the first detection electrodes being disposed at least any of [{360/(N−1)}×S]° apart from the reference driving electrode and [{360/(N−1)}×{S+(½)}]° apart from the reference driving electrode,
(3) second detection electrodes for detecting a second secondary vibration having a vibration axis {90/(N−1)}° apart from that of the first secondary vibration, the second detection electrodes being disposed at least any of [{360/(N−1)}×{S+(¼)}]° apart from the reference driving electrode and [{360/(N−1)}×{S+(¾)}]° apart from the reference driving electrode,
(4) first suppression electrodes for suppressing the first secondary vibration in accordance with signals outputted from the first detection electrodes, the first suppression electrodes being disposed at least any of [{360/(N−1)}×S]° apart from the reference driving electrode and [{360/(N−1)}×{S+(½)}]° apart from the reference driving electrode, and
(5) second suppression electrodes for suppressing the second secondary vibration in accordance with signals outputted from the second detection electrodes, the second suppression electrodes being disposed at least any of [{360/(N−1)}×{S+¼}]° apart from the reference driving electrode and [{360/(N−1)}×{S+(¾)}]° apart from the reference driving electrode.

Moreover, the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge, and
the first detection electrodes, the second detection electrodes, the first suppression electrodes, and the second suppression electrodes are each disposed on a second electrode disposition portion and are not electrically connected to the first electrode disposition portion.

In this vibrating gyroscope, since a piezoelectric element is formed as an electrode in the specific region described above on the plane of the ring-shaped vibrating body, the vibrating gyroscope functions as a biaxial angular velocity sensor and is capable of exciting the primary vibration as well as detecting the secondary vibration. In other words, this vibrating gyroscope is configured to excite the primary vibration in a plane identical with the plane (an X-Y plane, for example) including the piezoelectric element on the ring-shaped vibrating body as well as to control the motions of the ring-shaped vibrating body, with no piezoelectric element being formed on a side surface of the ring-shaped vibrating body. As a result, it is possible to fabricate the electrodes and the ring-shaped vibrating body with a high degree of accuracy in accordance with the dry process technique. Further, it is recognized as significantly advantageous that this vibrating gyroscope is capable of detecting a biaxial (each of the X axis and the Y axis, for example) angular velocity by adopting an out-of-plane vibration mode.

A different vibrating gyroscope according to the present invention includes: a ring-shaped vibrating body having a uniform plane; leg portions flexibly supporting the ring-shaped vibrating body; a plurality of electrodes disposed on the plane of or above the ring-shaped vibrating body, and formed with at least one of an upper-layer metallic film and a lower-layer metallic film; and a piezoelectric film being sandwiched between the upper-layer metallic film and the lower-layer metallic film in a thickness direction thereof. The plurality of electrodes include
(1) when N is a natural number of 2 or more, driving electrodes for exciting a primary vibration of the ring-shaped vibrating body in a vibration mode of cos Nθ, the driving electrodes being disposed (360/N)° apart from each other in a circumferential direction. The plurality of electrodes further include at least one of
(2) first detection electrodes for detecting a first secondary vibration in a vibration mode of cos(N+1)θ generated when an angular velocity is applied to the ring-shaped vibrating body, and, when one of the driving electrodes is referred to as a reference driving electrode and S is equal to 0, 1, . . . , N, the first detection electrodes being disposed at least any of [{360/(N+1)}×S]° apart from the reference driving electrode and [{360/(N+1)}×{S+(½)}]° apart from the reference driving electrode, and
(3) second detection electrodes different from the first detection electrodes, the second detection electrodes for detecting a second secondary vibration which has a vibration axis {90/(N+1)}° apart from that of the first secondary vibration, is in a vibration mode of cos(N+1)θ, and is generated when an angular velocity is applied to the ring-shaped vibrating body, the second detection electrodes being disposed at least any of [{360/(N+1)}×{S+(¼)}]° apart from the reference driving electrode and [{360/(N+1)}×{S+(¾)}]° apart from the reference driving electrode. The plurality of electrodes further include
(4) third detection electrodes for detecting a third secondary vibration which has a vibration axis (90/N)° apart from that of the primary vibration, is in a vibration mode of cos Nθ, and is generated when an angular velocity is applied to the ring-shaped vibrating body, and, when M is equal to 0, 1, . . . , N−1, the third detection electrodes being disposed at least any of [(360/N)×{M+(¼)}]° apart from the reference driving electrode and [(360/N)×{M+(¾)}]° apart from the reference driving electrode, and
(5) suppression electrodes for suppressing the secondary vibration in accordance with signals outputted from the third detection electrodes, and, when M is equal to 0, 1, . . . , N−1, the suppression electrodes being disposed at least any of [(360/N)×{M+(¼)}]° apart from the reference driving electrode and [(360/N)×{M+(¾)}]° apart from the reference driving electrode.

Moreover, the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge,

the first detection electrodes and the second detection electrodes are each disposed on a second electrode disposition portion and are not electrically connected to any one of the driving electrodes, and

the third detection electrodes and the suppression electrodes are each disposed on the first electrode disposition portion and are not electrically connected to any one of the driving electrodes.

A different vibrating gyroscope according to the present invention includes: a ring-shaped vibrating body having a uniform plane; leg portions flexibly supporting the ring-shaped vibrating body; a plurality of electrodes disposed on the plane of or above the ring-shaped vibrating body, and formed with at least one of an upper-layer metallic film and a lower-layer metallic film; and a piezoelectric film being sandwiched between the upper-layer metallic film and the lower-layer metallic film in a thickness direction thereof. The plurality of electrodes include
(1) when N is a natural number of 3 or more, driving electrodes for exciting a primary vibration of the ring-shaped vibrating body in a vibration mode of cos Nθ, the driving electrodes being disposed (360/N)° apart from each other in a circumferential direction. The plurality of electrodes further include at least one of
(2) first detection electrodes for detecting a first secondary vibration in a vibration mode of cos(N−1)θ generated when an angular velocity is applied to the ring-shaped vibrating body, and, when one of the driving electrodes is referred to as a reference driving electrode and S is equal to 0, 1, . . . , N−2, the first detection electrodes being disposed at least any of [{360/(N−1)}×S]° apart from the reference driving electrode and [{360/(N−1)}×{S+(½)}]° apart from the reference driving electrode, and
(3) second detection electrodes different from the first detection electrodes, the second detection electrodes for detecting a second secondary vibration which has a vibration axis {90/(N−1)}° apart from that of the first secondary vibration, is in a vibration mode of cos(N−1)θ, and is generated when an angular velocity is applied to the ring-shaped vibrating body, the second detection electrodes being disposed at least any of [{360/(N−1)}×{S+(¼)}]° apart from the reference driving electrode and [{360/(N−1)}×{S+(¾)}]° apart from the reference driving electrode. The plurality of electrodes further include
(4) third detection electrodes for detecting a third secondary vibration which has a vibration axis (90/N)° apart from that of the primary vibration, is in a vibration mode of cos Nθ, and is generated when an angular velocity is applied to the ring-shaped vibrating body, and, when M is equal to 0, 1, . . . , N−1, the third detection electrodes being disposed at least any of [(360/N)×{M+(¼)}]° apart from the reference driving electrode and [(360/N)×{M+(¾)}]° apart from the reference driving electrode, and
(5) suppression electrodes for suppressing the secondary vibration in accordance with signals outputted from the third detection electrodes, and, when M is equal to 0, 1, . . . , N−1, the suppression electrodes being disposed at least any of [(360/N)×{M+(¼)}]° apart from the reference driving electrode and [(360/N)×{M+(¾)}]° apart from the reference driving electrode.

Moreover, the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge,

the first detection electrodes and the second detection electrodes are each disposed on a second electrode disposition portion and are not electrically connected to any one of the driving electrodes, and

the third detection electrodes and the suppression electrodes are each disposed on the first electrode disposition portion and are not electrically connected to any one of the driving electrodes.

In each of these vibrating gyroscopes, since a piezoelectric element is formed as an electrode in the specific region described above on the plane of the ring-shaped vibrating body, the vibrating gyroscope functions as a triaxial angular velocity sensor and is capable of exciting the primary vibration as well as detecting the secondary vibration. In other words, this vibrating gyroscope is configured to excite the primary vibration in a plane identical with the plane (an X-Y plane, for example) including the piezoelectric element on the ring-shaped vibrating body, to detect and suppress the secondary vibration of the ring-shaped vibrating body in the plane, as well as to detect the motions of the ring-shaped vibrating body in a direction not included in the plane, with no piezoelectric element being formed on a side surface of the ring-shaped vibrating body. As a result, it is possible to fabricate the electrodes and the ring-shaped vibrating body with a high degree of accuracy in accordance with the dry process technique. Further, this vibrating gyroscope is capable of detecting a biaxial (each of the X axis and the Y axis, for example) angular velocity by adopting an out-of-plane vibration mode. Moreover, detection can be made by the feedback of suppressing the secondary vibration generated by an angular velocity about the Z axis, and both the S/N ratio and the responsiveness are advantageously maintained at high levels.

Further, it is a preferred aspect to add monitor electrodes configured according to (8) described below to the plurality of electrodes of the above uniaxial, biaxial, or triaxial vibrating gyroscope, since the disposition of other electrode groups and/or the metal tracks is facilitated in a limited planar region of a ring-shaped vibrating body that is particularly reduced in size:
(8) when L is equal to 0, 1, . . . , 2N−1, a group of monitor electrodes disposed so as not to be (180/N)×{L+(½)}° apart from the reference driving electrode in the circumferential direction.

### EFFECTS OF THE INVENTION

In a vibrating gyroscope according to the present invention, since a piezoelectric element is formed as an electrode in the specific region described above on the plane of the ring-shaped vibrating body, the vibrating gyroscope functions as a uniaxial and/or triaxial angular velocity sensor and is capable of exciting the primary vibration, detecting the secondary vibration, as well as suppressing at least the uniaxial secondary vibration. In other words, this vibrating gyroscope is configured to excite the primary vibration in a plane identical with the plane (an X-Y plane, for example) including the piezoelectric element on the ring-shaped vibrating body as well as to control the motions of the ring-shaped vibrating body, with no piezoelectric element being formed on a side surface of the ring-shaped vibrating body. As a result, it is possible to fabricate the electrodes and the ring-shaped vibrating body with a high degree of accuracy in accordance with the dry process technique. This vibrating gyroscope is capable of detecting a uniaxial to triaxial angular velocity by adopting a detector for a secondary vibration inclusive of an out-of-plane vibration mode.

### BRIEF DESCRIPTION OF THE DRAWINGS

FIG. 1 is a front view of a structure having a principal function in a ring-shaped vibrating gyroscope according to an embodiment of the present invention.

FIG. 2 is a sectional view taken along line A-A of FIG. 1.

FIG. 3A is a sectional view showing a process in the steps of manufacturing a part of the ring-shaped vibrating gyroscope according to the embodiment of the present invention.

FIG. 3B is a sectional view showing a process in the steps of manufacturing the part of the ring-shaped vibrating gyroscope according to the embodiment of the present invention.

FIG. 3C is a sectional view showing a process in the steps of manufacturing the part of the ring-shaped vibrating gyroscope according to the embodiment of the present invention.

FIG. 3D is a sectional view showing a process in the steps of manufacturing the part of the ring-shaped vibrating gyroscope according to the embodiment of the present invention.

FIG. 3E is a sectional view showing a process in the steps of manufacturing the part of the ring-shaped vibrating gyroscope according to the embodiment of the present invention.

FIG. 3F is a sectional view showing a process in the steps of manufacturing the part of the ring-shaped vibrating gyroscope according to the embodiment of the present invention.

FIG. 4 is a front view of a structure having a principal function in a ring-shaped vibrating gyroscope according to an embodiment of the present invention.

FIG. 5 is a front view of a structure having a principal function in a ring-shaped vibrating gyroscope according to an embodiment of the present invention.

FIG. 6 is a front view of a structure having a principal function in a ring-shaped vibrating gyroscope according to a different embodiment of the present invention.

FIG. 7 is a front view of a structure having a principal function in a ring-shaped vibrating gyroscope according to a different embodiment of the present invention.

FIG. 8 is a sectional view, which corresponds to FIG. 2, of a structure having a principal function in a ring-shaped vibrating gyroscope according to a different embodiment of the present invention.

FIG. 9 is a front view of a structure having a principal function in a ring-shaped vibrating gyroscope according to a different embodiment of the present invention.

FIG. 10 is a sectional view taken along line B-B of FIG. 8.

FIG. 11 is a front view of a structure having a principal function in a ring-shaped vibrating gyroscope according to a different embodiment of the present invention.

FIG. 12 is a front view of a structure having a principal function in a ring-shaped vibrating gyroscope according to a different embodiment of the present invention.

FIG. 13 is a front view of a structure having a principal function in a ring-shaped vibrating gyroscope according to a different embodiment of the present invention.

FIG. 14A is a front view of a structure having a principal function in a ring-shaped vibrating gyroscope according to a different embodiment of the present invention.

FIG. 14B is a front view of a structure having a principal function in a ring-shaped vibrating gyroscope according to a different embodiment of the present invention.

FIG. 14C is a front view of a structure having a principal function in a ring-shaped vibrating gyroscope according to a different embodiment of the present invention.

FIG. 14D is a front view of a structure having a principal function in a ring-shaped vibrating gyroscope according to a different embodiment of the present invention.

FIG. 14E is a front view of a structure having a principal function in a ring-shaped vibrating gyroscope according to a different embodiment of the present invention.

FIG. 15 is a front view of a structure having a principal function in a ring-shaped vibrating gyroscope according to a different embodiment of the present invention.

FIG. 16 is a front view of a structure having a principal function in a ring-shaped vibrating gyroscope according to a different embodiment of the present invention.

FIG. 17 is a front view of a structure having a principal function in a ring-shaped vibrating gyroscope according to a different embodiment of the present invention.

FIG. 18 is a front view of a structure having a principal function in a ring-shaped vibrating gyroscope according to a different embodiment of the present invention.

FIG. 19 is a front view of a structure having a principal function in a ring-shaped vibrating gyroscope according to a different embodiment of the present invention.

FIG. 20A is a view conceptually illustrating a primary vibration in a vibration mode of cos 2θ according to an embodiment of the present invention.

FIG. 20B is a view conceptually illustrating a secondary vibration in an in-plane vibration mode of cos 2θ in a case where an angular velocity is applied about a Z axis, according to an embodiment of the present invention.

FIG. 20C is a view conceptually illustrating positive/negative polarities of electrical signals of third detection electrodes.

FIG. 20D is a view conceptually illustrating a secondary vibration in an out-of-plane vibration mode of cos 3θ in a case where an angular velocity is applied about an X axis, according to an embodiment of the present invention.

FIG. 20E is a view conceptually illustrating a secondary vibration in an out-of-plane vibration mode of cos 3θ in a case where an angular velocity is applied about a Y axis, according to an embodiment of the present invention.

FIG. 21A is a view conceptually illustrating a primary vibration in a vibration mode of cos 3θ in the different embodiment of the present invention.

FIG. 21B is a view conceptually illustrating a secondary vibration in an out-of-plane vibration mode of cos 2θ in a case where an angular velocity is applied about an X axis, according to a different embodiment of the present invention.

FIG. 21C is a view conceptually illustrating a secondary vibration in an out-of-plane vibration mode of cos 2θ in a case where an angular velocity is applied about a Y axis, according to a different embodiment of the present invention.

FIG. 21D is a view conceptually illustrating a secondary vibration in a vibration mode of cos 3θ in a case where an angular velocity is applied about a Z axis, according to a different embodiment of the present invention.

### DESCRIPTION OF SYMBOLS

10: silicon substrate
11, 11a, 11b: ring-shaped vibrating body
12: alternating-current power supply
13a: driving electrode
13b, 13c: first detection electrode
13d, 13e: second detection electrode
13f, 13g: third detection electrode
13h: monitor electrode
13j, 13k: first suppression electrode
13m, 13n: second suppression electrode
13p, 13q: third suppression electrode
14: metal track
15: leg portion
16: fixed potential electrode (ground electrode)
17: electrode pad fixed end
18: electrode pad
19: post
20: silicon oxide film
30: lower-layer metallic film
40: piezoelectric film
50: upper-layer metallic film
60: fixed end
62, 63, 64: feedback control circuit
100, 110, 120, 300, 310, 400, 500, 600, 610, 620, 700, 720, 740, 760, 780, 900, 910, 920, 1000: ring-shaped vibrating gyroscope

### MODES FOR CARRYING OUT THE INVENTION

Embodiments of the present invention are described below in detail with reference to the accompanying drawings. In this disclosure, common parts are denoted by common reference symbols in all the drawings unless otherwise specified. Further, in these drawings, the elements of these embodiments are not necessarily illustrated in accordance with the same scale.

### First Embodiment

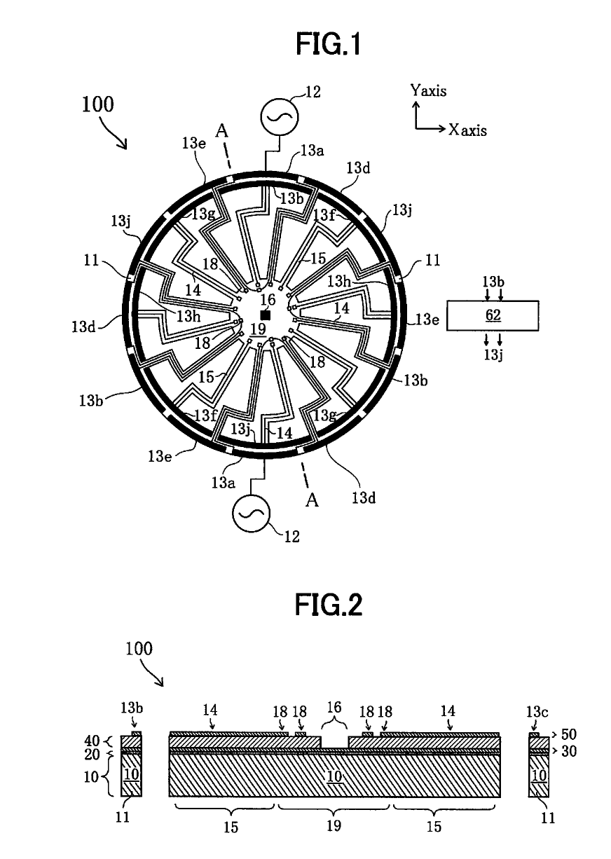

FIG. 1 is a front view of a structure having a principal function in a ring-shaped vibrating gyroscope 100 for measuring a triaxial angular velocity according to the present embodiment. FIG. 2 is a sectional view taken along line A-A of FIG. 1. For the purpose of easier illustration, an X axis and a Y axis are indicated in FIG. 1.

As shown in FIGS. 1 and 2, the ring-shaped vibrating gyroscope 100 according to the present embodiment is generally divided into three structural portions. A first structural portion includes a ring-shaped vibrating body 11 formed with a silicon substrate 10, a silicon oxide film 20 on an upper plane (hereinafter, referred to as an upper surface) of the ring-shaped vibrating body 11, and a plurality of electrodes 13a to 13h formed thereon with a lower-layer metallic film 30 and an upper-layer metallic film 50, and a piezoelectric film 40 sandwiched between the lower-layer metallic film 30 and the upper-layer metallic film 50. In the present embodiment, the upper-layer metallic film 50 configuring the plurality of electrodes 13a to 13h has an outer end or an inner end formed inside by approximately 1 μm with respect to the outer peripheral edge or the inner peripheral edge of the ring-shaped vibrating body 11 that has a ring-shaped plane of approximately 40 μm wide, so as to be approximately 18 μm wide. In the upper-layer metallic film 50, some of the electrodes are formed outside a line connecting centers (hereinafter, simply referred to as a center line) of both ends in the width direction of the ring-shaped plane that serves as the upper surface of the ring-shaped vibrating body 11. The remaining electrodes are formed inside the center line.

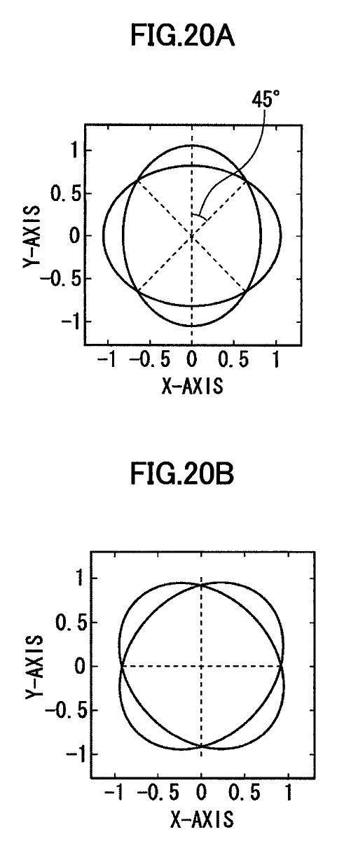

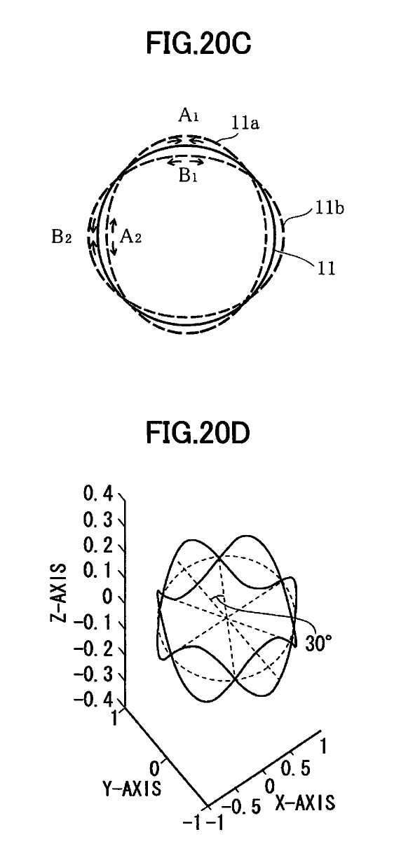

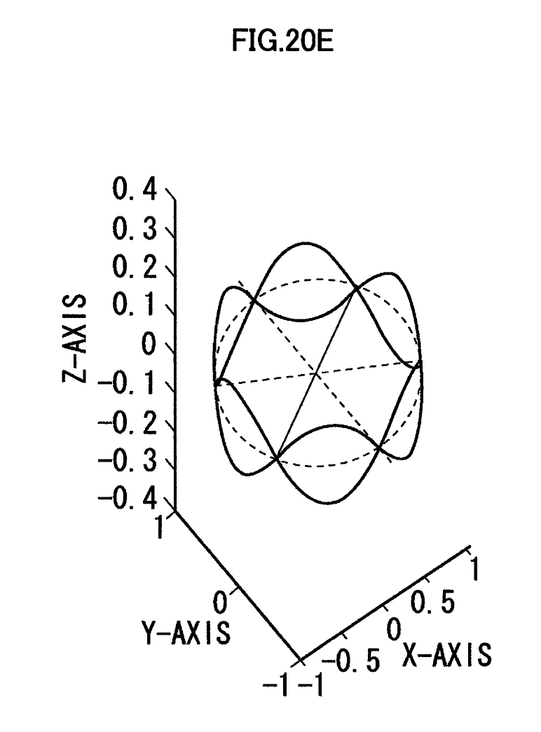

In the present embodiment, a primary vibration of the ring-shaped vibrating gyroscope 100 is excited in an in-plane vibration mode of cos 2θ as indicated in FIG. 20A. A secondary vibration in the present embodiment has an out-of-plane vibration mode of cos 3θ with respect to the X axis as indicated in FIG. 20D, an out-of-plane vibration mode of cos 3θ with respect to the Y axis as indicated in FIG. 20E, and an in-plane vibration mode of cos 2θ with respect to an axis (a Z axis) as indicated in FIG. 20B.

Thus, the plurality of electrodes 13a to 13h are categorized as follows. Firstly, two driving electrodes 13a, 13a are disposed 180° apart from each other in a circumferential direction. In a case where one of the above two driving electrodes 13a, 13a (for example, the driving electrode 13a disposed in the direction of twelve o'clock in FIG. 1) is referred to as a reference electrode, two monitor electrodes 13h, 13h are disposed 90° and 270° respectively apart from this driving electrode 13a in the circumferential direction. Assume that an X-Y plane is defined so as to be along the plane of the ring-shaped vibrating body on which a piezoelectric element is disposed, in other words, so as to be included in the drawing sheet of FIG. 1. In this case, first detection electrodes 13b are disposed 0°, 120°, and 240° respectively apart from the reference electrode in the circumferential direction. Each of the first detection electrodes 13b detects a secondary vibration generated when an angular velocity about the X axis is applied to the ring-shaped vibrating gyroscope 100. In addition to the first detection electrodes, in the present embodiment, first suppression electrodes 13j are disposed 60°, 180°, and 300° respectively apart from the reference electrode in the circumferential direction. Each of the first suppression electrodes 13j receives a signal for suppressing a secondary vibration of the ring-shaped vibrating gyroscope 100 generated by an angular velocity about the X axis.

The ring-shaped vibrating gyroscope 100 is further provided with second detection electrodes 13d, 13e that are disposed 30°, 90°, 150°, 210°, 270°, and 330° respectively apart from the reference electrode in the circumferential direction. Each of the second detection electrodes 13d, 13e detects a secondary vibration generated when an angular velocity about the Y axis is applied. In addition, third detection electrodes 13f, 13g are disposed, each of which detects a secondary vibration generated when an angular velocity about the Z axis, that is, an axis perpendicular to the plane on which the ring-shaped vibrating gyroscope 100 shown in FIG. 1 is disposed (namely, an axis perpendicular to the drawing sheet, which is hereinafter referred to simply as a “perpendicular axis” or the “Z axis”), is applied to the ring-shaped vibrating gyroscope 100. It is noted that, in the present embodiment, the third detection electrodes 13f, 13g are disposed 45°, 135°, 225°, and 315° respectively apart from the reference electrode in the circumferential direction.

In the present embodiment, the lower-layer metallic film 30 and the upper-layer metallic film 50 are 100 nm thick, respectively, and the piezoelectric film 40 is 3 μm thick. Further, the silicon substrate 10 is 100 μm thick.

In the present embodiment and other embodiments to be described later, there are two categorized portions in which the respective electrodes are disposed. One of the portions is referred to as a first electrode disposition portion, in which the driving electrodes 13a and the third detection electrodes 13f, 13g are respective disposed. The first electrode disposition portion includes a region from the outer peripheral edge of the upper surface of the ring-shaped vibrating body 11 to the vicinity of the outer peripheral edge and/or a region from the inner peripheral edge thereof to the vicinity of the inner peripheral edge. Another one of the two portions is referred to as a second electrode disposition portion, in which the first detection electrodes 13b, the first suppression electrodes 13j, the second detection electrodes 13d, 13e, and the third detection electrodes 13f, 13g are disposed. The second electrode disposition portion is located on the upper surface of the ring-shaped vibrating body 11 so as not to be electrically connected to the first electrode disposition portion. More specifically, the first detection electrodes 13b, the first suppression electrodes 13j, the second detection electrodes 13d, 13e, and the third detection electrodes 13f, 13g are disposed so as not to be electrically connected to any one of the two driving electrodes 13a, 13a.

A second structural portion includes leg portions 15, . . . , 15 that are each connected to a part of the ring-shaped vibrating body 11. These leg portions 15, . . . , 15 are also formed with the silicon substrate 10. Formed on the entire upper surfaces of the leg portions 15, . . . , 15 are the silicon oxide film 20, the lower-layer metallic film 30, and the piezoelectric film 40 described above, which are provided continuously to the portions of the respective films on the ring-shaped vibrating body 11. Further formed on the upper surface of the piezoelectric film 40 is the upper-layer metallic film 50 which configures metal tracks 14, . . . , 14 of approximately 8 μm wide.

In the present embodiment, the plurality of metal tracks 14 are formed on four leg portions 15, . . . , 15 out of the sixteen leg portions 15, . . . , 15. These metal tracks 14 are formed to obtain paths to electrode pads 18 on a post 19 from the respective electrodes that are disposed in the region from the outer peripheral edge of the ring-shaped vibrating body 11 to the vicinity of the outer peripheral edge. Particularly in the present embodiment, the metal tracks 14, 14 are provided from both ends of each of the second detection electrodes 13d, 13e so as to eliminate variations in electrical signals from the second detection electrodes 13d, 13e. The function of the vibrating gyroscope is not affected even in a case where the metal tracks 14, 14 are provided only from either of the ends of the respective second detection electrodes 13d, 13e.

A third structural portion includes the post 19 that is formed with the silicon substrate 10 provided continuously to the portions of the above leg portions 15, . . . , 15. In the present embodiment, the post 19 is connected to a package portion (not shown) of the ring-shaped vibrating gyroscope 100 and serves as a fixed end. The post 19 is provided with the electrode pads 18, . . . , 18. As shown in FIG. 2, formed on the upper surface of the post 19 are the silicon oxide film 20, the lower-layer metallic film 30, and the piezoelectric film 40 described above, which are provided continuously to the portions of the respective films on the leg portions 15, . . . , 15 except for the portion of a fixed potential electrode 16 that functions as a ground electrode. In this case, the lower-layer metallic film 30 formed on the silicon oxide film 20 functions as the fixed potential electrode 16. On the upper surface of the piezoelectric film 40 formed above the post 19, there are formed the electrode pads 18, . . . , 18 and the metal tracks 14, . . . , 14 which are provided continuously to the portions of the metal tracks on the leg portions 15, . . . , 15.

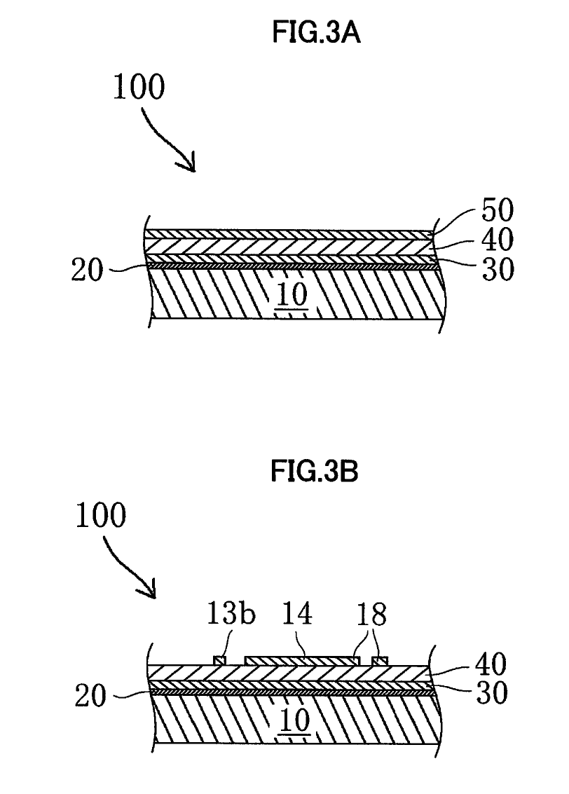

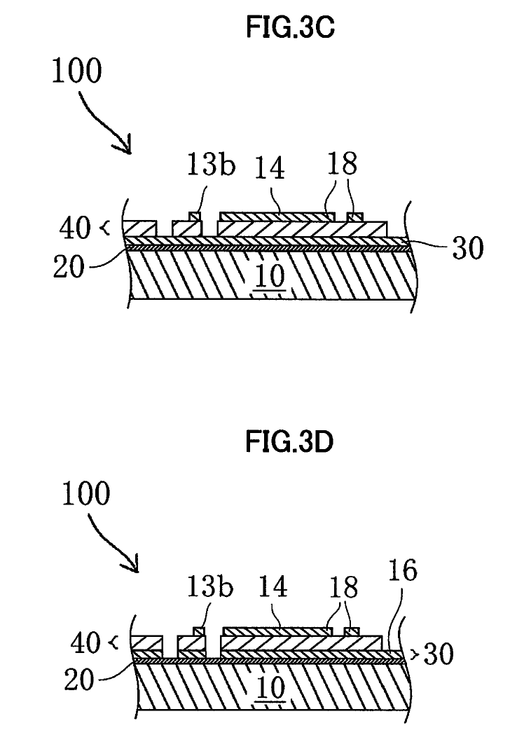

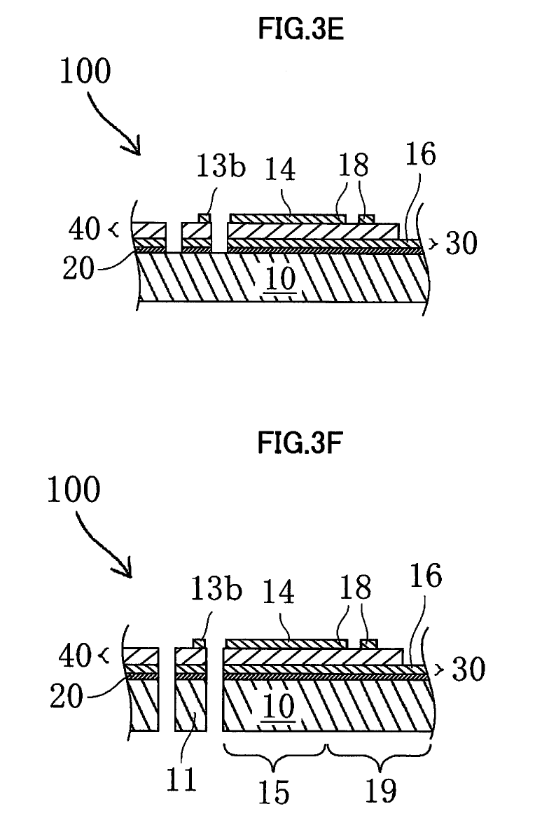

Described next with reference to FIGS. 3A to 3F is a method for manufacturing the ring-shaped vibrating gyroscope 100 according to the present embodiment. FIGS. 3A to 3F are sectional views each showing a part of the portion shown in FIG. 2.

Firstly, as shown in FIG. 3A, laminated on the silicon substrate 10 are the silicon oxide film 20, the lower-layer metallic film 30, the piezoelectric film 40, and the upper-layer metallic film 50. Each of these films is formed by known film formation means. In the present embodiment, the silicon oxide film 20 is a thermally oxidized film obtained by known means. The lower-layer metallic film 30, the piezoelectric film 40, and the upper-layer metallic film 50 are each formed in accordance with a known sputtering method. It is noted that formation of each of these films is not limited to the example described above but these films may be alternatively formed by any other known means.

The upper-layer metallic film 50 is then partially etched. In the present embodiment, there is formed a known resist film on the upper-layer metallic film 50, and dry etching is then performed on the basis of a pattern formed in accordance with the photolithographic technique, so that the respective electrodes shown are formed as in FIG. 3B. In this case, the upper-layer metallic film 50 is dry etched under the condition for the known reactive ion etching (RIE) using argon (Ar) or mixed gas containing argon (Ar) and oxygen (O₂).

Thereafter, as shown in FIG. 3C, the piezoelectric film 40 is partially etched. Firstly, similarly to the above, the piezoelectric film 40 is dry etched on the basis of the resist film that is patterned in accordance with the photolithographic technique. In the present embodiment, the piezoelectric film 40 is dry etched under the condition for the known reactive ion etching (RIE) using mixed gas containing argon (Ar) and C₂F₆ gas, or mixed gas containing argon (Ar), C₂F₆ gas, and CHF₃ gas.

Then, as shown in FIG. 3D, the lower-layer metallic film 30 is partially etched. In the present embodiment, dry etching is performed using the resist film that is again patterned in accordance with the photolithographic technique, so as to form the fixed potential electrode 16 including the lower-layer metallic film 30. The fixed potential electrode 16 in the present embodiment is utilized as the ground electrode. In the present embodiment, the lower-layer metallic film 30 is dry etched under the condition for the known reactive ion etching (RIE) using argon (Ar) or mixed gas containing argon (Ar) and oxygen (O₂).

In the present embodiment, the resist film is formed to be approximately 4 μm thick so that the silicon oxide film 20 and the silicon substrate 10 are then continuously etched with the above resist film having formed again serving as an etching mask. However, even in a case where this resist film disappears during etching the silicon substrate 10, the selectivity of the etching rate relative to an etchant applied to the silicon substrate 10 functions advantageously. Therefore, the performance of any one of the upper-layer metallic film 50, the piezoelectric film 40, and the lower-layer metallic film 30 is not substantially affected by the above etching. In other words, in the present embodiment, since the ring-shaped vibrating body 11 is formed with the silicon substrate, it is possible to apply the known silicon trench etching technique with an adequately high selectivity also relative to the resist film. Even in a case where the resist film disappears, there is provided an adequate selectivity such that the upper-layer metallic film or the piezoelectric film layered therebelow serves as a mask for etching silicon.

Thereafter, as shown in FIGS. 3E and 3F, the silicon oxide film 20 and the silicon substrate 10 are dry etched as described above using the resist film that is provided for etching the lower-layer metallic film 30. In the present embodiment, the silicon oxide film 20 was dry etched under the condition for the known reactive ion etching (RIE) using argon (Ar) or mixed gas containing argon (Ar) and oxygen (O₂). The known silicon trench etching technique is applied as the condition for dry etching the silicon substrate 10 in the present embodiment. In this case, the silicon substrate 10 is etched so as to be penetrated. Thus, the dry etching described above is performed in a state where a protective substrate, which prevents a stage to allow the silicon substrate 10 to be mounted thereon from being exposed to plasma upon penetration, is attached to the silicon substrate 10 with grease of high thermal conductivity or the like so as to form a layer under the silicon substrate 10. Accordingly, it is a preferred aspect to adopt the dry etching technique disclosed in Japanese Unexamined Patent Publication No. 2002-158214, for example, in order to prevent corrosion of a surface perpendicular to the thickness direction of the silicon substrate 10, in other words, an etching side surface, after the penetration.

As described above, the silicon substrate 10 and the respective films laminated on the silicon substrate 10 are etched to form the principal structure of the ring-shaped vibrating gyroscope 100. Subsequently performed are the step of accommodating the principal structure into the package by known means as well as the step of wiring. As a result, there is obtained the ring-shaped vibrating gyroscope 100. Therefore, this vibrating gyroscope 100, which has no piezoelectric element on a side surface of the ring-shaped vibrating body 11, realizes excitation of an in-plane primary vibration as well as detection of maximally triaxial out-of-plane and in-plane secondary vibrations only with use of the piezoelectric element formed on the plane of the ring-shaped vibrating body 11. As a result, it is possible to manufacture the vibrating gyroscope 100 in accordance with the above dry process technique that realizes low cost mass production with a high degree of accuracy.

Described next are the functions of the respective electrodes included in the ring-shaped vibrating gyroscope 100. As already described, excited in the present embodiment is a primary vibration in an in-plane vibration mode of cos 2θ. Because the fixed potential electrode 16 is grounded, the lower-layer metallic film 30, which is provided continuously to the portion on the fixed potential electrode 16, is uniformly set to 0 V.

As shown in FIG. 1, firstly, an alternating-current voltage of 1 VP-0 is applied to each of the two driving electrodes 13a, 13a. As a result, the piezoelectric film 40 is expanded and contracted to excite a primary vibration. In the present embodiment, the upper-layer metallic film 50 is formed outside the center line in the upper surface of the ring-shaped vibrating body 11 in a front view. Accordingly, it is possible to convert the expansion/contraction motions of the piezoelectric film 40 into a primary vibration of the ring-shaped vibrating body 11 with no piezoelectric element being provided on a side surface of the ring-shaped vibrating body 11. Actual alternating-current power supplies 12 each apply to the corresponding driving electrode 13a by way of the corresponding electrode pad 18 that is connected to a conductive wire. However, the alternating-current power supplies 12 are not referred to in the present embodiment and in the other embodiments, for the purpose of easier illustration.

Then, each of the monitor electrodes 13h, 13h shown in FIG. 1 detects an amplitude and a resonant frequency of the above primary vibration, and transmits a signal to a known feedback control circuit (not shown). The feedback control circuit in the present embodiment controls using the signals outputted from the monitor electrodes 13h, 13h such that the frequency of the alternating-current voltage applied to each of the driving electrodes 13a, 13a is equal to the natural frequency of the ring-shaped vibrating body 11, as well as such that the amplitude of the ring-shaped vibrating body 11 has a constant value. As a result, the ring-shaped vibrating body 11 is vibrated constantly and continuously.

After the excitation of the primary vibration described above, upon application of an angular velocity about the perpendicular axis (the Z axis), in the present embodiment in the in-plane vibration mode of cos 2θ, generated by a coriolis force is a secondary vibration indicated in FIG. 20B, having a new vibration axis that is inclined at 45° to either side with respect to the vibration axis of the primary vibration indicated in FIG. 20A.

This secondary vibration is detected by the two detection electrodes (third detection electrodes) 13f, 13f as well as by the two other detection electrodes (third detection electrodes) 13g, 13g. In the present embodiment, as shown in FIG. 1, each of the detection electrodes 13f, 13g is disposed in correspondence with its vibration axis of the in-plane secondary vibration. Moreover, the respective detection electrodes 13f, 13g are formed inside the center line in the upper surface of the ring-shaped vibrating body 11. Therefore, the respective detection electrodes 13f, 13g generate electrical signals of positive/negative polarities inverse to each other in accordance with the in-plane secondary vibration excited upon the application of the angular velocity. As shown in FIG. 20C, when, for example, the ring-shaped vibrating body 11 is transformed into a vibration state shown as a vibrating body 11a in a vertically longer elliptical shape, the piezoelectric film 40 at the angle of the third detection electrode 13f disposed inside the center line is contracted in directions indicated by arrows A1, while the piezoelectric film 40 at the angle of the third detection electrode 13g disposed inside the center line is expanded in directions indicated by arrows A2. Accordingly, the electrical signals of these electrodes have positive/negative polarities inverse to each other. Similarly, when the ring-shaped vibrating body 11 is transformed into a vibration state shown as a vibrating body 11b in a horizontally longer elliptical shape, the piezoelectric film 40 at the angle of the third detection electrode 13f is expanded in directions indicated by arrows B1, while the piezoelectric film 40 at the angle of the third detection electrode 13g is contracted in directions indicated by arrows B2. Accordingly, also in this case, the electrical signals of these electrodes have positive/negative polarities inverse to each other.

Then, obtained in an arithmetic circuit functioning as a known difference circuit are differences between the electrical signals of the respective third detection electrodes 13f, 13g. Resulting detection signals of this case have approximately doubled detectability in comparison to the case with only one type of the detection electrodes.

Described below is a case where an angular velocity is applied about the X axis after the excitation of the primary vibration described above. Excited in this case is a secondary vibration in a vibration mode of cos 3θ as indicated in FIG. 20D.

This secondary vibration is detected by the three detection electrodes (first detection electrodes) 13b, 13b, 13b. In the present embodiment, as shown in FIG. 1, each of the detection electrodes 13b is disposed in correspondence with its vibration axis of the secondary vibration in the out-of-plane mode of cos 3θ.

In the present embodiment, the respective detection electrodes 13b are formed outside or inside the center line in the upper surface of the ring-shaped vibrating body 11. However, the embodiments of the present invention are not limited to such a case. In different disposition of electrodes according to another aspect, the detection electrode 13b disposed in the direction of twelve o'clock out of the three detection electrodes 13b, 13b, 13b shown in FIG. 1 can be replaced with the driving electrode 13a disposed in the direction of twelve o'clock, and the first suppression electrode 13j disposed in the direction of six o'clock out of the three first suppression electrodes 13j, 13j, 13j can be replaced with the driving electrode 13a disposed in the direction of six o'clock. Even in this case, in the secondary vibration in the mode of cos 3θ (FIG. 20D) in accordance with an angular velocity about the X axis, the three detection electrodes 13b, 13b, 13b output signals in coordinate phases, so that the secondary vibration can be appropriately detected. Further, such a secondary vibration can be appropriately suppressed by a voltage applied to each of the three first suppression electrodes 13j, 13j, 13j.

In further different disposition of electrodes according to still another aspect, the respective detection electrodes 13b can be disposed so as to include the center line in the plane of the ring-shaped vibrating body 11. This is one of more preferred aspects in comparison to the disposition of electrodes according to the above aspect because the piezoelectric film is least deformed by the in-plane primary vibration or the secondary vibration with respect to the Z axis.

Electrical signals of the respective detection electrodes 13b are detected by a known circuit that is capable of detecting voltages. In this case, the ring-shaped vibrating gyroscope 100 according to the present embodiment includes a first feedback control circuit 62 for suppressing a secondary vibration. The first feedback control circuit 62 instructs or controls to apply a voltage to each of the first suppression electrodes 13j, so as to cancel the voltage signals related to the secondary vibration detected by these first detection electrodes 13b, in other words, in order to set the values of these voltage signals to zero. The value of the voltage applied to each of the first suppression electrodes 13j, or a value corresponding to the voltage is used as a resultant output of the vibrating gyroscope on an angular velocity about the X axis. It is noted that, in the present application, the vibration axis has an azimuth that allows the recited vibration to have a largest amplitude, and such an azimuth is indicated by a direction on the ring-shaped vibrating body. In an exemplary case of the secondary vibration indicated in FIG. 20D, vibration axes are located at the positions of 0°, 60°, 120°, 180°, 240°, and 300°, respectively counterclockwise from the direction of twelve o'clock.

Described below is a case where an angular velocity is applied about the Y axis after the excitation of the primary vibration described above. Excited in this case is a secondary vibration in a vibration mode of cos 3θ as indicated in FIG. 20E. This secondary vibration is in another out-of-plane vibration mode of cos 3θ which has a vibration axis 30° apart from that of the vibration mode of cos 3θ indicated in FIG. 20D.

This secondary vibration is detected by the three detection electrodes (second detection electrodes) 13d, 13d, 13d as well as by the three other detection electrodes (second detection electrodes) 13e, 13e, 13e. In the present embodiment, as shown in FIG. 1, each of the detection electrodes 13d, 13e is disposed in correspondence with its vibration axis of the out-of-plane secondary vibration. The respective detection electrodes 13d, 13e in the present embodiment are formed outside the center line in the upper surface of the ring-shaped vibrating body 11. However, the present invention is not limited to such a case. It is rather a preferred aspect to dispose the respective detection electrodes 13d, 13e so as to include the center line, in which state the piezoelectric film is least deformed by the in-plane primary vibration or the secondary vibration with respect to the Z axis. With the disposition of the respective detection electrodes 13d, 13e in the present embodiment, the respective detection electrodes 13d, 13e generate electrical signals of positive/negative polarities inverse to each other in accordance with the out-of-plane secondary vibration excited upon the application of the angular velocity.

Thus, similarly to the above case, obtained in an arithmetic circuit functioning as a known difference circuit are differences between the electrical signals of the respective detection electrodes 13d, 13e. Resulting detection signals of this case have approximately doubled detectability in comparison to the case with only one type of the detection electrodes.

In the present embodiment, the first suppression electrodes 13j are provided for suppressing a secondary vibration on the basis of voltage signals outputted from the first detection electrodes 13b. The first feedback control circuit 62 for suppressing a secondary vibration applies, to each of the first suppression electrodes 13j, an electrical signal for suppressing a secondary vibration. Accordingly, the ring-shaped vibrating gyroscope 100 can exert the performance as a vibrating gyroscope with almost no secondary vibration being caused to the ring-shaped vibrating body 11 by an angular velocity about the X axis, in other words, a secondary vibration in a mode such as indicated in FIG. 20D. It is noted that the ring-shaped vibrating gyroscope 100 according to the present embodiment is significantly excellent in noise performance in comparison to a vibrating gyroscope that does not include the first suppression electrodes 13j and the first feedback control circuit for suppressing a secondary vibration. More specifically, the ring-shaped vibrating gyroscope 100 according to the present embodiment generates noise of a volume, in the low frequency region upon detection of an angular velocity about the X axis, which is only a half or less of that of an exemplary vibrating gyroscope (the vibrating gyroscope according to the first embodiment) disclosed in PCT/JP2009/052960, as having been previously proposed by the applicant of the present invention. Accordingly, in the detection of an angular velocity about the X axis, the S/N ratio can be remarkably improved without deteriorating responsiveness. It is noted that any known feedback control circuit is applicable to the above first feedback control circuit 62 for suppressing a secondary vibration.

In the first embodiment described above, for the purpose of easier description, the detection electrodes are referred to as the first detection electrodes to the third detection electrodes, each of which detects one axial component of a triaxial angular velocity to be detected. Alternatively, the detection electrodes for the respective axes may be each arbitrarily referred to as one of the first detection electrode to the third detection electrode so as to be differentiated from one another.

### Modification (1) of First Embodiment

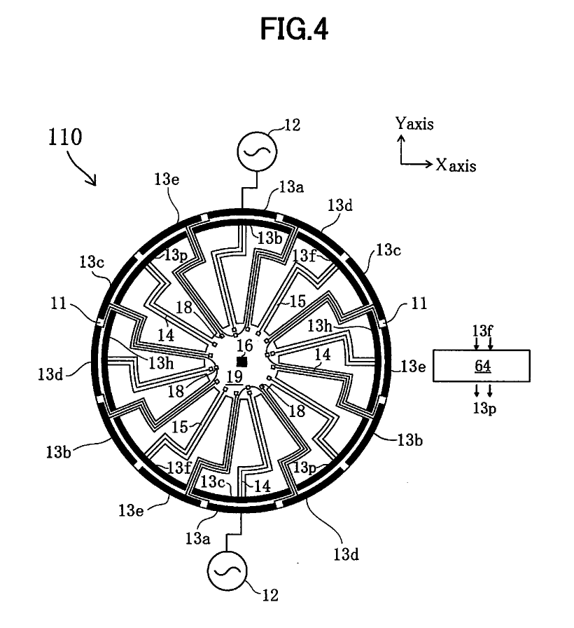

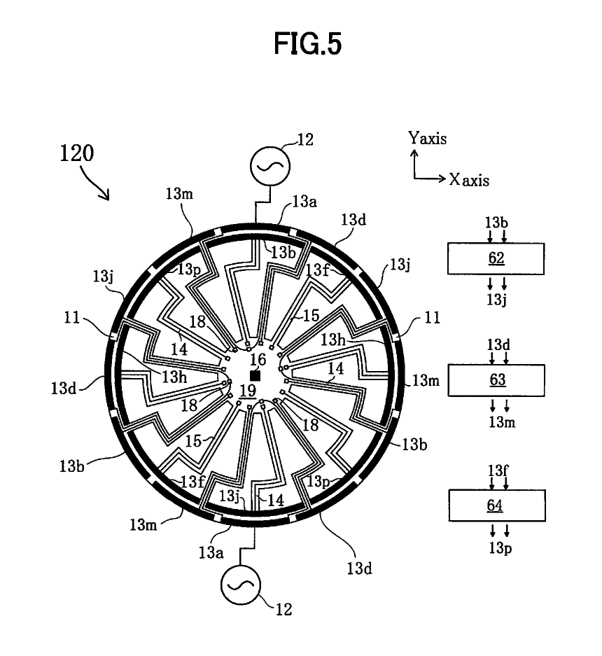

Described next is modification (1) of the first embodiment with reference to FIG. 4. FIG. 4 is a front view of a structure having a principal function in a ring-shaped vibrating gyroscope 110 for measuring a triaxial angular velocity.

The ring-shaped vibrating gyroscope 110 according to this modification includes third suppression electrodes 13p for suppressing a secondary vibration generated when an angular velocity about the Z axis is applied. It is noted that the ring-shaped vibrating gyroscope 110 does not include the first suppression electrodes 13j of the ring-shaped vibrating gyroscope 100 in the embodiment shown in FIG. 1, but is provided with first detection electrodes 13c at those angular positions. Thus, similarly to the detection of an angular velocity about the Y axis in the ring-shaped vibrating gyroscope 100, also in the detection of an angular velocity about the X axis in the ring-shaped vibrating gyroscope 110, an arithmetic circuit functioning as a known difference circuit obtains differences between electrical signals of the respective detection electrodes 13b, 13c.

In the ring-shaped vibrating gyroscope 110, the third suppression electrodes 13p are disposed 135° and 315° respectively apart in the circumferential direction from the reference electrode disposed in the direction of twelve o'clock in the figure. These third suppression electrodes 13p respectively replace the third detection electrodes 13g that are included in the ring-shaped vibrating gyroscope 100 shown in FIG. 1. The third suppression electrodes 13p are connected with a third feedback control circuit 64 for suppressing a secondary vibration. The third feedback control circuit 64 for suppressing a secondary vibration receives signals outputted from the third detection electrodes 13f. Any known feedback control circuit is applicable to the above third feedback control circuit 64 for suppressing a secondary vibration.

The third feedback control circuit 64 for suppressing a secondary vibration instructs or controls to apply a voltage to each of the third suppression electrodes 13p, so as to cancel the voltage signals related to the secondary vibration detected by the third detection electrodes 13f, in other words, in order to set the values of these voltage signals to zero. The value of the voltage applied to each of the third suppression electrodes 13p, or a value corresponding to the voltage is used as a resultant output of the vibrating gyroscope on an angular velocity about the Z axis.

In the case of this modification, similarly to the suppression of the secondary vibration in accordance with an angular velocity about the X axis in the first embodiment described above, suppressed is the secondary vibration (the secondary vibration indicated in FIG. 20B) in accordance with an angular velocity about the Z axis. Therefore, both the S/N ratio and the responsiveness can be maintained in the measurement of the angular velocity about the Z axis.

### Modification (2) of First Embodiment

Described next is modification (2) of the first embodiment with reference to FIG. 5. FIG. 5 is a front view of a structure having a principal function in a ring-shaped vibrating gyroscope 120 for measuring a triaxial angular velocity. In this modification, there are provided suppression electrodes for suppressing a secondary vibration generated when an angular velocity about each of the X, Y, and Z axes is applied.

Described first is disposition of electrodes on the plane of the ring-shaped vibrating body 11 in the ring-shaped vibrating gyroscope 120 according to this modification, by referring to arrangements modified from the ring-shaped vibrating gyroscope 100 according to the embodiment shown in FIG. 1. In the embodiment shown in FIG. 1, the first suppression electrodes 13j are disposed 60°, 180°, and 300° respectively apart from the reference electrode in the circumferential direction, in order to suppress a secondary vibration generated by an angular velocity about the X axis. In addition to the above, similarly to the ring-shaped vibrating gyroscope 110 according to the modification (1) described above, there are also included the third suppression electrodes 13p in order to suppress a secondary vibration generated by an angular velocity about the Z axis. The third suppression electrodes 13p are disposed similarly to those in the ring-shaped vibrating gyroscope 110. In addition to these, the ring-shaped vibrating gyroscope 120 is further provided with second suppression electrodes 13m for suppressing a secondary vibration generated by an angular velocity about the Y axis. These second suppression electrodes 13m are disposed 90°, 210°, and 330° respectively apart from the reference electrode in the circumferential direction. The second suppression electrodes 13m respectively replace the second detection electrodes 13b that are included in the ring-shaped vibrating gyroscope 100 shown in FIG. 1.

In the ring-shaped vibrating gyroscope 120 according to this modification, in addition to the first feedback control circuit 62 that is connected to the first suppression electrodes 13j and suppresses a secondary vibration, the third feedback control circuit 64 for suppressing a secondary vibration is connected to the third suppression electrodes 13p as in the ring-shaped vibrating gyroscope 110. There is further provided a second feedback control circuit 63 that is connected to the second suppression electrodes 13m and suppresses a secondary vibration. The first feedback control circuit 62 for suppressing a secondary vibration and the third feedback control circuit 64 for suppressing a secondary vibration operate similarly to those of the ring-shaped vibrating gyroscope 100 and the ring-shaped vibrating gyroscope 110, respectively.

The second feedback control circuit 63 for suppressing a secondary vibration instructs or controls to apply a voltage to each of the second suppression electrodes 13m, so as to cancel the voltage signals related to the secondary vibration detected by the second detection electrodes 13d (the secondary vibration indicated in FIG. 20E), in other words, in order to set the values of these voltage signals to zero. The value of the voltage applied to each of the second suppression electrodes 13m, or a value corresponding to the voltage is used as a resultant output on an angular velocity about the Y axis.

In this modification, an operation for the suppression of a secondary vibration is exerted with respect to an angular velocity about any one of the X, Y, and Z axes. Therefore, both the S/N ratio and the responsiveness can be maintained with respect to the angular velocity about an axis in an arbitrary direction.

### Modification (3) of First Embodiment

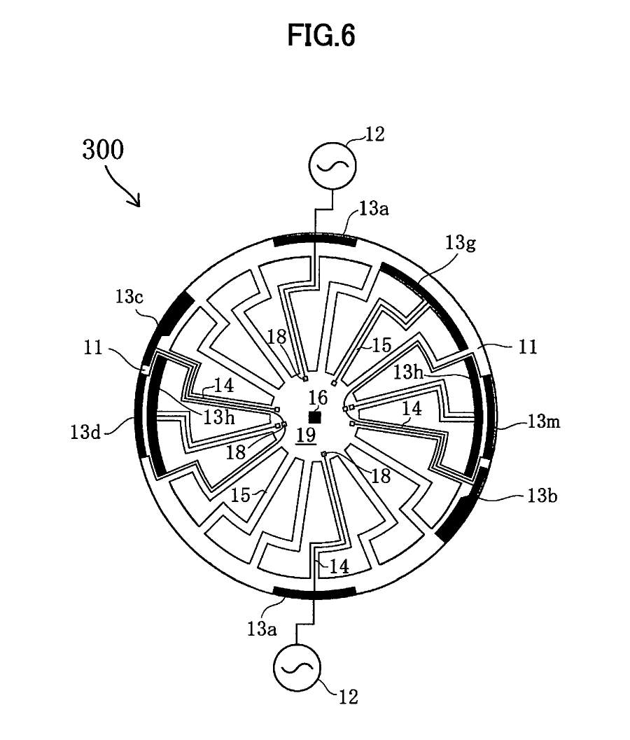

FIG. 6 is a front view of a structure having a principal function in a ring-shaped vibrating gyroscope 300 obtained by partial modification to the first embodiment.

The ring-shaped vibrating gyroscope 300 according to the present embodiment is configured identically with the ring-shaped vibrating gyroscope 100 of the first embodiment, except for the upper-layer metallic film 50 in the first embodiment. The manufacturing method therefor is identical with that of the first embodiment except for some steps. Further, the vibration modes of the primary vibration and the secondary vibration in the present embodiment are identical with those of the first embodiment. Accordingly, the description duplicating with that of the first embodiment will not be repeatedly provided.

As shown in FIG. 6, the ring-shaped vibrating gyroscope 300 according to the present embodiment is provided with the totally four detection electrodes 13b, 13c, 13d, 13g as well as the one second suppression electrode 13m. Further, as shown in FIG. 6, each of the first detection electrodes 13b, 13c has the electrode portion beyond the center line. The effects of the present invention are substantially exerted even with such disposition of the respective detection electrodes. More specifically, provision of the respective detection electrodes 13b, 13c, 13d, 13g achieves detection of a triaxial angular velocity, namely, detection of a biaxial (the X axis and the Y axis) angular velocity by adopting the out-of-plane vibration mode as well as detection of a uniaxial (the Z axis) angular velocity by adopting the in-plane vibration mode.

In this case, the second suppression electrode 13m is connected with the second feedback control circuit (not shown) for suppressing a secondary vibration. The second feedback control circuit for suppressing a secondary vibration receives a signal outputted from the second detection electrode 13d. The second feedback control circuit for suppressing a secondary vibration instructs or controls to apply a voltage to the second suppression electrode 13m in accordance with the output from the second detection electrode 13d, so as to cancel the voltage signals related to the secondary vibration (the secondary vibration indicated in FIG. 20E) generated by an angular velocity about the Y axis, which is detected by the second detection electrode 13d, in other words, in order to set the values of these voltage signals to zero. The value of the voltage applied to the second suppression electrode 13m, or a value corresponding to the voltage is used as a resultant output on an angular velocity about the Y axis. Accordingly, in the case of this modification, similarly to the suppression of the secondary vibration in accordance with an angular velocity about the X axis in the first embodiment described above, suppressed is the secondary vibration (the secondary vibration indicated in FIG. 20E) in accordance with an angular velocity about the Y axis. Therefore, in the ring-shaped vibrating gyroscope 300, both the S/N ratio and the responsiveness can be maintained in the measurement of the angular velocity about the Y axis.

It is a preferred aspect in the present embodiment that the first detection electrodes 13b, 13c are disposed so as to include the center line, as in the ring-shaped vibrating gyroscope 300. This aspect is preferred because the piezoelectric film is least deformed by the primary vibration in the in-plane vibration mode and the secondary vibration. Furthermore, it is a more preferred aspect to dispose the respective first detection electrodes 13b, 13c so as to be symmetrical with respect to the center line, in which state each of the first detection electrodes 13b, 13c is deformed in directions opposite to each other with respect to the center line in the in-plane vibration mode.

Even in a case where the plurality of first detection electrodes 13b, 13c are not disposed symmetrically with respect to the center line, the respective first detection electrodes 13b, 13c may be disposed in various ways so as to be unlikely to detect a vibration in an in-plane vibration mode in accordance with the vibration mode to be adopted. Accordingly, as described earlier, the second electrode disposition portion including the respective detection electrodes 13b, 13c, 13d, 13m is defined as a portion on the upper surface of the ring-shaped vibrating body 11 not electrically connected to the first electrode disposition portion.

In the present embodiment, each of the first detection electrodes 13b, 13c occupies an area larger than that of the first embodiment. Each of the first detection electrodes 13b, 13c is preferably disposed symmetrically with respect to its vibration axis of the secondary vibration (the secondary vibration indicated in FIG. 20D) detected by each of these electrodes. Further, the areas of only the first detection electrodes 13b, 13c are increased in the present embodiment. However, the present invention is not limited to such a case. For example, it is a preferred aspect to increase the area of the driving electrode, the monitor electrode, or the detection electrode different from the above, so as to improve the driving power or the detectability.

Because the respective electrodes of the present embodiment are eccentrically located, some of the leg portions 15 are not provided with the metal tracks 14. However, the present invention is not limited to such a case. Effects similar to those of the present embodiment are exerted even in a case where the leg portion 15 not provided with the metal track 14 is removed. However, random absence of the leg portion 15 may cause an irregular vibration of the ring-shaped vibrating body 11. It is therefore preferred to remove only the leg portions 15 that are allocated at equal angles.

### Modification (4) of First Embodiment

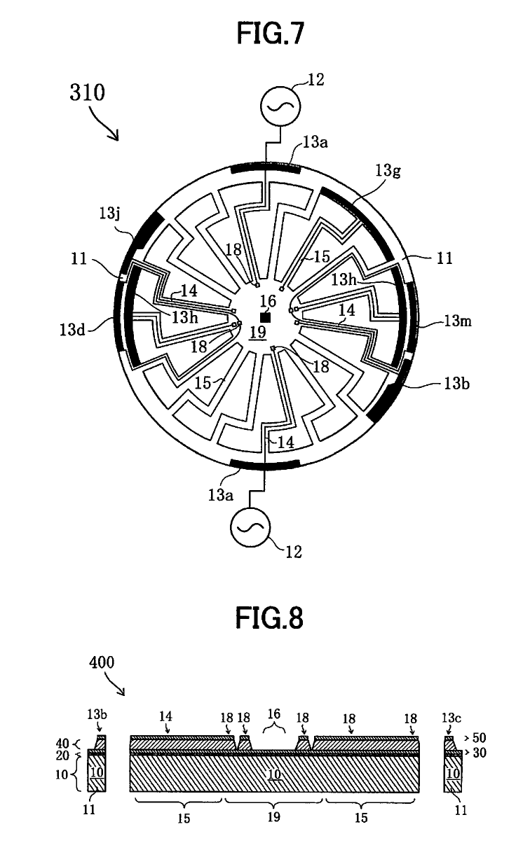

FIG. 7 is a front view of a structure having a principal function in a ring-shaped vibrating gyroscope 310 obtained by partial modification to the first embodiment.

The ring-shaped vibrating gyroscope 310 according to the present embodiment is configured identically with the ring-shaped vibrating gyroscope 100 of the first embodiment, except for the upper-layer metallic film 50 in the first embodiment. In particular, the first detection electrode 13c in the ring-shaped vibrating gyroscope 300 is replaced with the first suppression electrode 13j. Accordingly, the first suppression electrode 13j is connected with the first feedback control circuit (not shown) for suppressing a secondary vibration. The first feedback control circuit for suppressing a secondary vibration receives a signal outputted from the first detection electrode 13b. The first feedback control circuit for suppressing a secondary vibration instructs or controls to apply a voltage to the first suppression electrode 13j in accordance with the output from the first detection electrode 13b, so as to cancel the voltage signals related to the secondary vibration (the secondary vibration indicated in FIG. 20D) generated by an angular velocity about the X axis detected by the first detection electrode 13b, in other words, in order to set the values of these voltage signals to zero. The value of the voltage applied to the first suppression electrode 13j, or a value corresponding to the voltage is used as a resultant output on an angular velocity about the X axis. The ring-shaped vibrating gyroscope 310 according to the present embodiment maintains both the S/N ratio and the responsiveness on detection of an angular velocity about the Y axis, similarly to the ring-shaped vibrating gyroscope 300 according to the present embodiment. In addition, the ring-shaped vibrating gyroscope 310 can maintain both the S/N ratio and the responsiveness on detection of an angular velocity about the X axis.

### Modification (5) of First Embodiment

FIG. 8 is a sectional view, which corresponds to FIG. 2, of a structure having a principal function in a ring-shaped vibrating gyroscope 400 obtained by partial modification to the first embodiment.

As shown in FIG. 8, in the present embodiment, the piezoelectric film 40 is etched substantially in correspondence with the region where the upper-layer metallic film 50 is formed. The alternating-current voltage applied to the upper-layer metallic film 50 is thus directed only in the vertically downward direction with no influence of the region provided with the lower-layer metallic film 30. Prevented therefore are undesired expansion and contraction motions of the piezoelectric film 40 as well as transmission of an electrical signal. In the present embodiment, after the step of dry etching the upper-layer metallic film 50, dry etching is subsequently performed under the condition same as that of the first embodiment with the residual resist film on the upper-layer metallic film 50 or the upper-layer metallic film 50 itself serving as an etching mask. As a result, there is formed the piezoelectric film 40 described above. Further, as shown in FIG. 8, the piezoelectric film 40 in the present embodiment is etched so as to have an inclined shape (at an inclination angle of 75°, for example). However, the piezoelectric film 40 having such steep inclination as shown in FIG. 8 is dealt in the present application as being substantially visually unrecognized, as compared to other regions, in the front view of the ring-shaped vibrating gyroscope 100 shown in FIG. 1. Furthermore, the aspect disclosed in the present embodiment in which the piezoelectric film 40 is etched is applicable at least to all the embodiments in the present application.

### Modification (6) of First Embodiment

Described above in each of the first embodiment and the modifications (1) to (5) thereof is the configuration of the vibrating gyroscope that is capable of detecting a triaxial angular velocity and includes the suppression electrodes for suppressing a secondary vibration with respect to the angular velocity about one, two, and three axes. Also obtained from the first embodiment is the disposition of respective detection electrodes for detecting a biaxial or uniaxial angular velocity.

For example, when only the first detection electrodes 13b, 13c used for measuring an angular velocity about the X axis and the second detection electrodes 13d, 13e used for measuring an angular velocity about the Y axis, out of the first to third detection electrodes 13b, 13c, 13d, 13e, 13f, 13g, are disposed on the ring-shaped vibrating body 11, manufactured is a vibrating gyroscope for detection of a biaxial angular velocity. More specifically, it is possible to obtain the vibrating gyroscope for detection of a biaxial angular velocity by selecting the detection electrodes with respect to two axes out of the first to third detection electrodes. Further, only one type (for example, the first detection electrode 13b) out of the first detection electrodes 13b, 13c may be disposed on the ring-shaped vibrating body 11, and the first suppression electrode 13j may be provided. In this case, with use of the output from the first detection electrode 13b, it is possible to suppress a secondary vibration generated by an angular velocity about the X axis.

An idea similar to the above is applicable to the configuration of a vibrating gyroscope that is capable of detecting a uniaxial angular velocity. For example, when only the first detection electrode 13b used for measuring an angular velocity about the X axis, out of the first to third detection electrodes 13b, 13c, 13d, 13e, 13f, 13g, is disposed on the ring-shaped vibrating body 11, manufactured is a vibrating gyroscope for detecting a uniaxial angular velocity. Similarly, a secondary vibration can be suppressed by the first suppression electrode 13j.

### Modification (7) of First Embodiment

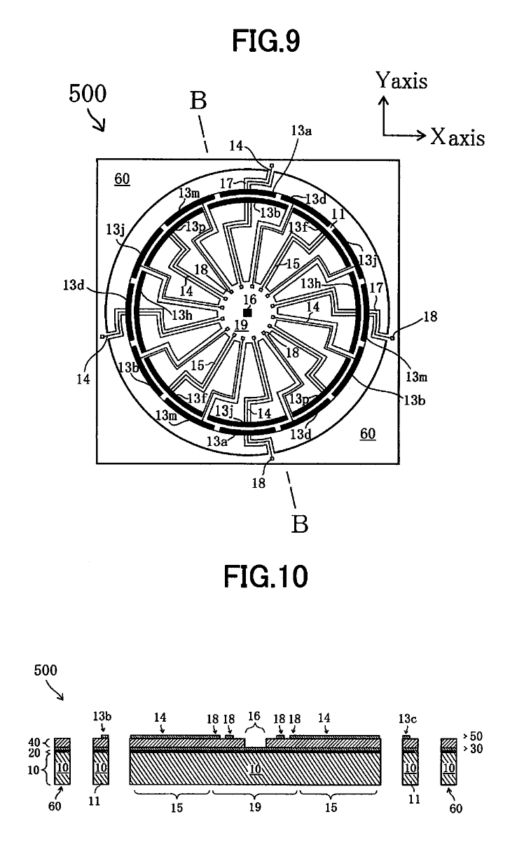

FIG. 9 is a front view of a structure having a principal function in a ring-shaped vibrating gyroscope 500 obtained by partial modification to the first embodiment. FIG. 10 is a sectional view taken along line B-B of FIG. 9.

In comparison to the first embodiment, the ring-shaped vibrating gyroscope 500 according to the present embodiment is provided with a fixed end 60 around the ring-shaped vibrating body 11 by way of grooves or leg portions 17. Formed on the leg portions 17 and the fixed end 60 are the electrode pads 18 and the metal tracks 14 that are drawn from the driving electrodes 13a, 13a and the second detection electrodes 13d, 13e. Further, due to the provision of the metal tracks 14 on the leg portions 17, there are not provided the metal tracks 14 and the electrode pads 18 on the leg portions 15 and the fixed end 19, respectively. The ring-shaped vibrating gyroscope 500 according to the present embodiment is configured identically with that of the first embodiment except for the above points. The manufacturing method therefor is identical with that of the first embodiment except for some steps. The vibration modes of the primary vibration and the secondary vibration in the present embodiment are identical with those of the first embodiment. Accordingly, the description duplicating with that of the first embodiment will not be repeatedly provided. In the present embodiment, alternating-current power supplies to be connected with the driving electrodes 13a, 13a are not illustrated for easier comprehension of the figure.

Due to the provision of the fixed end 60 and the leg portions 17 connecting the fixed end 60 and the ring-shaped vibrating body 11 in the ring-shaped vibrating gyroscope 500 of the present embodiment, it is unnecessary to dispose the plurality of metal tracks 14 on the leg portions 15 inside the ring-shaped vibrating body 11. Thus remarkably decreased are risks of short circuiting among the metal tracks due to some defect in the manufacturing steps or the like. As shown in FIG. 9, each of the metal tracks 14 is connected to the center portion in the longer side of the corresponding electrode, so that there are caused no variations in electrical signals from the driving electrodes 13a, 13a and the second detection electrodes 13d, 13e in the first embodiment. However, the provision of the fixed end 60 increases the size of the vibrating gyroscope in comparison to that of the first embodiment.

The ring-shaped vibrating gyroscope 500 thus configured also includes the first suppression electrodes 13j, thereby achieving suppression of a secondary vibration generated by an angular velocity about the X axis.

### Second Embodiment

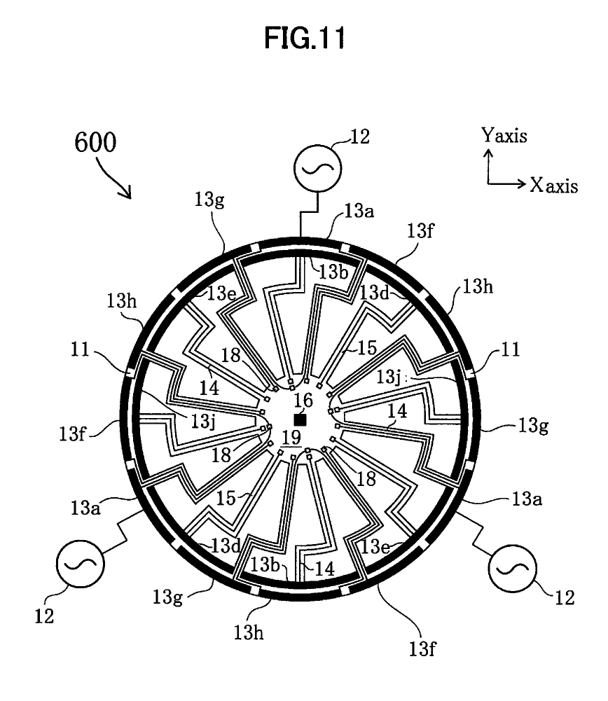

FIG. 11 is a front view of a structure having a principal function in a different ring-shaped vibrating gyroscope 600 for measuring a triaxial angular velocity according to the present embodiment.

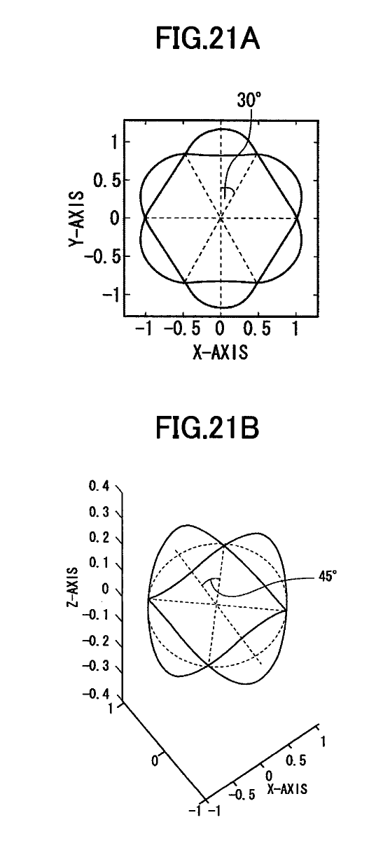

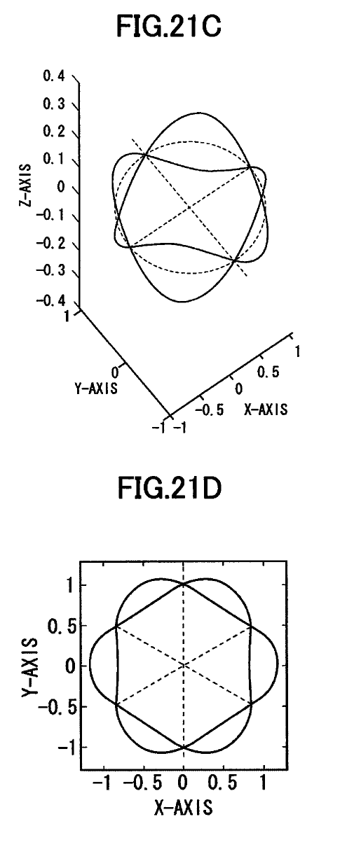

The ring-shaped vibrating gyroscope 600 according to the present embodiment is configured identically with the ring-shaped vibrating gyroscope 100 of the first embodiment except for the disposition of the driving electrodes 13a, the monitor electrodes 13h, the first detection electrodes 13b, the first suppression electrodes 13j, and some of the detection electrodes out of the second detection electrodes 13d, 13e and the third detection electrodes 13f, 13g in the first embodiment, as well as the disposition and the number of the alternating-current power supplies 12. The manufacturing method therefor is identical with that of the first embodiment. Accordingly, the description duplicating with that of the first embodiment will not be repeatedly provided. However, the primary vibration in the present embodiment has an in-plane vibration mode of cos 3θ as indicated in FIG. 21A. The secondary vibration in the present embodiment has an out-of-plane vibration mode of cos 2θ with respect to the X axis as indicated in FIG. 21B, an out-of-plane vibration mode of cos 2θ with respect to the Y axis as indicated in FIG. 21C, and an in-plane vibration mode of cos 3θ with respect to an axis (the Z axis) as indicated in FIG. 21D.

As shown in FIG. 11, also in the ring-shaped vibrating gyroscope 600 of the present embodiment, the upper-layer metallic film 50 configuring the plurality of electrodes 13a to 13h has an outer end provided inside by approximately 1 μm with respect to the outer peripheral edge of the ring-shaped vibrating body 11 that has a ring-shaped plane of approximately 40 μm wide, so as to be approximately 18 μm wide. The upper-layer metallic film 50 is provided outside or inside the center line.

In the present embodiment, excited to the ring-shaped vibrating gyroscope 600 is a primary vibration in an in-plane vibration mode of cos 3θ. On the other hand, a secondary vibration in the present embodiment has vibration modes indicated in FIGS. 21B to 21D. Thus, the plurality of electrodes 13a to 13h are categorized as follows. Firstly, there are the three driving electrodes 13a, 13a, 13a disposed 120° apart from each other in the circumferential direction. In a case where one of the above three driving electrodes 13a, 13a, 13a (for example, the driving electrode 13a disposed in the direction of twelve o'clock in FIG. 11) is referred to as a reference electrode, the three monitor electrodes 13h, 13h, 13h are disposed 60°, 180°, and 300° respectively apart from this driving electrode 13a in the circumferential direction. Assume that a plane provided with a piezoelectric element on the ring-shaped vibrating body, in other words, the drawing sheet of FIG. 11, is as an X-Y plane. In this case, the first detection electrodes 13b for detecting a secondary vibration generated when an angular velocity about the X axis is applied to the ring-shaped vibrating gyroscope 600 are disposed 0° and 180° respectively apart from the reference electrode in the circumferential direction. Further, the first suppression electrodes 13j are disposed 90° and 270° respectively apart from the reference electrode in the circumferential direction. For the purpose of detecting a secondary vibration generated when an angular velocity about the Y axis is applied to the ring-shaped vibrating gyroscope 600, the second detection electrodes 13d, 13e are disposed 45°, 135°, 225°, and 315° respectively apart from the reference electrode in the circumferential direction. Further, the third detection electrodes 13f, 13g are disposed, each of which detects a secondary vibration generated when an angular velocity about the Z axis, that is, an axis perpendicular to the plane on which the ring-shaped vibrating gyroscope 600 shown in FIG. 11 is disposed (namely, an axis perpendicular to the drawing sheet, which is hereinafter referred to simply as a “perpendicular axis” or the “Z axis”), is applied to the ring-shaped vibrating gyroscope 600. The third detection electrodes 13f, 13g according to the present embodiment are disposed 30°, 90°, 150°, 210°, 270°, and 330° respectively apart from the reference electrode in the circumferential direction.

Described below are the functions of the respective electrodes included in the ring-shaped vibrating gyroscope 600. As described earlier, excited in the present embodiment is a primary vibration in the in-plane vibration mode of cos 3θ. Because the fixed potential electrode 16 is grounded, the lower-layer metallic film 30, which is provided continuously to the portion on the fixed potential electrode 16, is uniformly set to 0 V.

Firstly, as shown in FIG. 11, an alternating-current voltage of 1 VP-0 is applied to each of the three driving electrodes 13a, 13a, 13a. As a result, the piezoelectric film 40 is expanded and contracted to excite a primary vibration. In the present embodiment, the upper-layer metallic film 50 is formed outside the center line in the upper surface of the ring-shaped vibrating body 11. Accordingly, it is possible to convert the expansion/contraction motions of the piezoelectric film 40 into the primary vibration of the ring-shaped vibrating body 11 with no upper-layer metallic film 50 being provided on a side surface of the ring-shaped vibrating body 11.

Then, each of the monitor electrodes 13h, 13h, 13h shown in FIG. 11 detects an amplitude and a resonant frequency of the above primary vibration, and transmits a signal to a known feedback control circuit (not shown). The feedback control circuit in the present embodiment controls such that the frequency of the alternating-current voltage applied to each of the driving electrodes 13a, 13a, 13a is equal to the natural frequency of the ring-shaped vibrating body 11, as well as controls such that the amplitude of the ring-shaped vibrating body 11 has a constant value, with use of the signals from the monitor electrodes 13h, 13h, 13h. As a result, the ring-shaped vibrating body 11 is vibrated constantly and continuously.

After the excitation of the primary vibration described above, upon application of an angular velocity about the perpendicular axis (the Z axis), in the present embodiment in the in-plane vibration mode of cos 3θ, generated by a coriolis force is a secondary vibration indicated in FIG. 21D, having a new vibration axis that is inclined at 30° to either side with respect to the vibration axis of the primary vibration indicated in FIG. 21A.

This secondary vibration is detected by the three detection electrodes (third detection electrodes) 13f, 13f, 13f as well as by the three other detection electrodes (third detection electrodes) 13g, 13g, 13g. In the present embodiment, similarly to the first embodiment, obtained in an arithmetic circuit functioning as a known difference circuit are differences between the electrical signals of the respective third detection electrodes 13f, 13g. Resulting detection signals of this case have approximately doubled detectability in comparison to the case with only one type of the detection electrodes.

Described below is a case where an angular velocity is applied about the X axis after the excitation of the primary vibration described above. Excited in this case is the secondary vibration in the out-of-plane vibration mode of cos 2θ indicated in FIG. 21B.

This secondary vibration is detected by the two detection electrodes (first detection electrodes) 13b. Output signals therefrom are received by the first feedback control circuit (not shown) for suppressing a secondary vibration, while each of the first suppression electrodes 13j receives an output from the first feedback control circuit for suppressing a secondary vibration. In the present embodiment, as shown in FIG. 11, the detection electrodes 13b and the first suppression electrodes 13j are each disposed in correspondence with its vibration axis of the out-of-plane secondary vibration. Moreover, the detection electrodes 13b and the first suppression electrodes 13j in the present embodiment are formed respectively inside the center line in the upper surface of the ring-shaped vibrating body 11. However, the present invention is not limited to such a case. It is rather a preferred aspect to respectively dispose the detection electrodes 13b and the first suppression electrodes 13j so as to include the center line, in which state the piezoelectric film is least deformed by the primary vibration in the in-plane vibration mode and the secondary vibration. Furthermore, it is a more preferred aspect to respectively dispose the detection electrodes 13b and the first suppression electrodes 13j so as to be symmetrical with respect to the center line, in which state the piezoelectric film is deformed in directions opposite to each other with respect to the center line in the in-plane vibration mode.

Because of the disposition of the two first detection electrodes 13b in the present embodiment, the two first detection electrodes 13b generate electrical signals theoretically having completely identical waveforms, in accordance with the out-of-plane secondary vibration excited upon the application of an angular velocity. Nevertheless, in an actual ring-shaped vibrating gyroscope, erroneous alignment is caused in any way between the pattern in the formation of the respective electrodes and the pattern in the formation of the ring-shaped vibrating body 11. In such a case, the first detection electrode 13b disposed in the direction of twelve o'clock and the first detection electrode 13b disposed in the direction of six o'clock are shifted in directions opposite to each other with respect to the ring-shaped vibrating body 11. For example, if the first detection electrode 13b in the direction of twelve o'clock is shifted toward the outer peripheral edge of the ring-shaped vibrating body 11, the first detection electrode 13b in the direction of six o'clock is shifted toward the inner peripheral edge thereof. Accordingly, these first detection electrodes are shifted so as to cancel each other the displacement in position, particularly in the radial direction of the ring, on the plane of the ring-shaped vibrating body 11. This is a preferred feature because, upon extracting paralelly connected electrical signals to be detected by the first detection electrodes 13b, 13b, absolute values of the outputs will be less likely to be affected by the erroneous alignment.

Described below is a case where an angular velocity is applied about the Y axis after the excitation of the primary vibration described above. Excited in this case is the secondary vibration in the vibration mode of cos 2θ indicated in FIG. 21C, which has a vibration axis inclined at 45° from that of the vibration mode of cos 2θ described above.

This secondary vibration is detected by the two detection electrodes (second detection electrodes) 13d, 13d as well as by the two other detection electrodes (second detection electrodes) 13e, 13e. In the present embodiment, as shown in FIG. 11, the detection electrodes 13d, 13e are each disposed in correspondence with its vibration axis of the out-of-plane secondary vibration. Moreover, the respective detection electrodes 13d, 13e in the present embodiment are formed inside the center line in the upper surface of the ring-shaped vibrating body 11. However, the present invention is not limited to such a case. It is rather a preferred aspect to dispose the respective detection electrodes 13d, 13e so as to include the center line, in which state the piezoelectric film is least deformed by the primary vibration in the in-plane vibration mode and the secondary vibration. Furthermore, it is a more preferred aspect to dispose the respective detection electrodes 13d, 13e so as to be symmetrical with respect to the center line, in which state each of the detection electrodes 13d, 13e is deformed in directions opposite to each other with respect to the center line in the in-plane vibration mode.

Because of the disposition of the respective detection electrodes 13d, 13e in the present embodiment, the detection electrodes 13d, 13e generate electrical signals of positive/negative polarities inverse to each other in accordance with the out-of-plane secondary vibration excited upon application of an angular velocity. Thus, obtained in an arithmetic circuit functioning as a known difference circuit are differences between the electrical signals of the respective detection electrodes 13d, 13e. Resulting detection signals of this case have approximately doubled detectability in comparison to the case with only one type of the detection electrodes.

In the first embodiment described above, for the purpose of easier description, the detection electrodes are referred to as the first detection electrodes to the third detection electrodes, each of which detects one axial component of a triaxial angular velocity to be detected. Alternatively, the detection electrodes for the respective axes may be each arbitrarily referred to as one of the first detection electrode to the third detection electrode so as to be differentiated from one another.

### Modification (1) of Second Embodiment

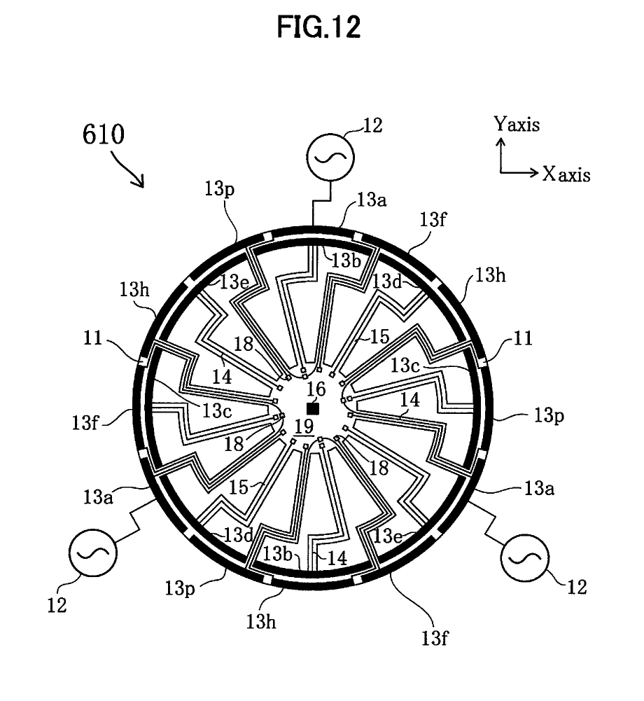

Described next is modification (1) of the second embodiment with reference to FIG. 12. FIG. 12 is a front view of a structure having a principal function in a ring-shaped vibrating gyroscope 610 for measuring a triaxial angular velocity.

The ring-shaped vibrating gyroscope 610 according to this modification includes the third suppression electrodes 13p, 13p, 13p for suppressing a secondary vibration generated when an angular velocity about the Z axis is applied. It is noted that the ring-shaped vibrating gyroscope 610 does not include the first suppression electrodes 13j of the ring-shaped vibrating gyroscope 600 in the embodiment shown in FIG. 11, but is provided with the first detection electrodes 13c at those angular positions. Thus, similarly to the detection of an angular velocity about the Y axis in the ring-shaped vibrating gyroscope 600, also in the detection of an angular velocity about the X axis in the ring-shaped vibrating gyroscope 610, an arithmetic circuit functioning as a known difference circuit obtains differences between the electrical signals of the respective detection electrodes 13b, 13c.

In the ring-shaped vibrating gyroscope 610, the third suppression electrodes 13p are disposed 90°, 210°, and 330° respectively apart in the circumferential direction from the reference electrode disposed in the direction of twelve o'clock in the figure. These third suppression electrodes 13p respectively replace the third detection electrodes 13g that are included in the ring-shaped vibrating gyroscope 600 shown in FIG. 11. The third suppression electrodes 13p are connected with the third feedback control circuit (not shown) for suppressing a secondary vibration. The third feedback control circuit for suppressing a secondary vibration receives signals outputted from the third detection electrodes 13f. Similarly to the respective embodiments having been described, any known feedback control circuit is applicable to the third feedback control circuit for suppressing a secondary vibration.

The third feedback control circuit for suppressing a secondary vibration instructs or controls to apply a voltage to each of the third suppression electrodes 13p, so as to cancel the voltage signals related to the secondary vibration detected by the third detection electrodes 13f, in other words, in order to set the values of these voltage signals to zero. The value of the voltage applied to each of the third suppression electrodes 13p, or a value corresponding to the voltage is used as a resultant output of the vibrating gyroscope on an angular velocity about the Z axis.

In the case of this modification, similarly to the suppression of the secondary vibration in accordance with an angular velocity about the X axis in the first embodiment described above, suppressed is the secondary vibration (the secondary vibration indicated in FIG. 21D) in accordance with an angular velocity about the Z axis. Therefore, both the S/N ratio and the responsiveness can be maintained in the measurement of the angular velocity about the Z axis.

### Modification (2) of Second Embodiment

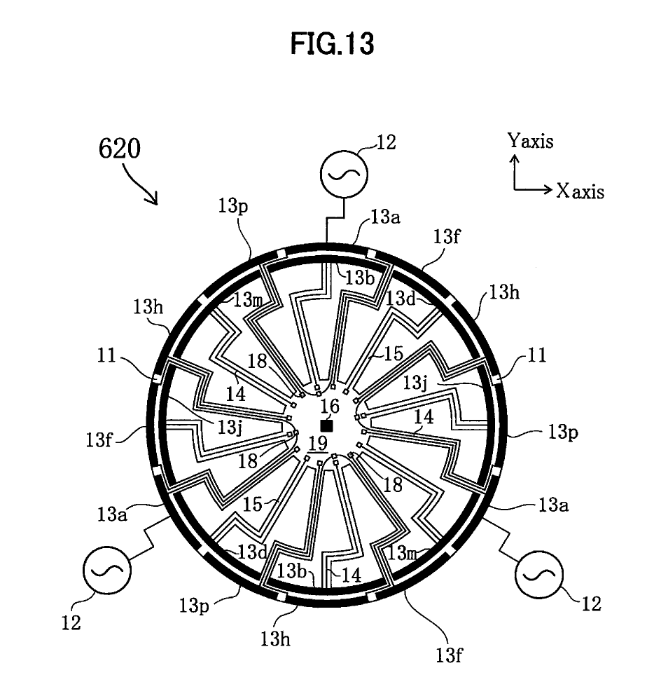

Described next is modification (2) of the second embodiment with reference to FIG. 13. FIG. 13 is a front view of a structure having a principal function in a ring-shaped vibrating gyroscope 620 for measuring a triaxial angular velocity. In this modification, there are provided suppression electrodes for suppressing a secondary vibration generated when an angular velocity about each of the X, Y, and Z axes is applied.

Described is disposition of electrodes on the plane of the ring-shaped vibrating body 11 in the ring-shaped vibrating gyroscope 620 according to this modification, by referring to arrangements modified from the ring-shaped vibrating gyroscope 600 according to the embodiment shown in FIG. 11. This description is similar to the description of the configuration of the ring-shaped vibrating gyroscope 120 according to the modification (2) of the first embodiment by referring to the arrangements modified from the ring-shaped vibrating gyroscope 100 according to the first embodiment. More specifically, the ring-shaped vibrating gyroscope 620 includes the first suppression electrodes 13j similarly to the ring-shaped vibrating gyroscope 600 of the embodiment shown in FIG. 11, the second suppression electrodes 13m, and also includes the third suppression electrodes 13p similarly to the ring-shaped vibrating gyroscope 610 of the modification (1) described above.

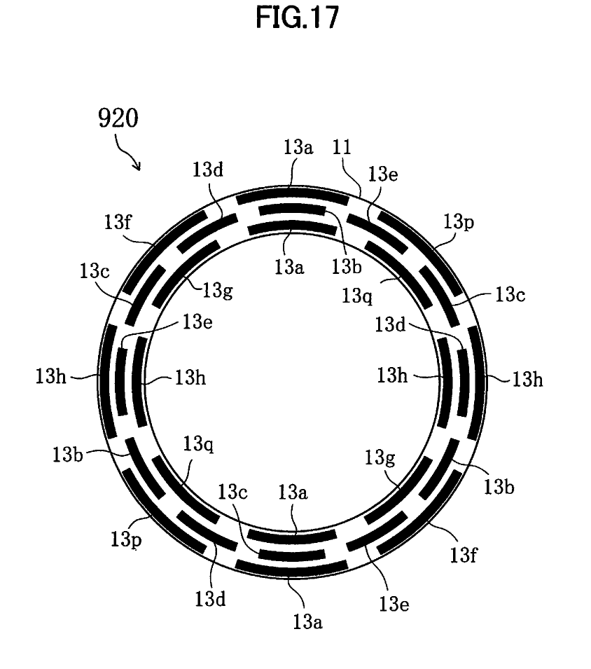

Also in the ring-shaped vibrating gyroscope 620 according to this modification, the first, second, and third feedback control circuits for suppressing a secondary vibration are connected to the first, second, and third suppression electrodes 13j, 13m, and 13p, respectively. the first, second, and third feedback control circuits for suppressing a secondary vibration receive signals outputted from the first, second, and third detection electrodes 13b, 13d, and 13f, respectively. In this configuration, a voltage is applied to each of the first, second, and third suppression electrodes so as to cancel the voltage signals related to the secondary vibrations (the secondary vibrations indicated in FIGS. 17B, 17C, and 17D, respectively) detected by the first, second, and third detection electrodes 13b, 13d, 13f. Accordingly, in this modification, an operation for the suppression of a secondary vibration is exerted onto an angular velocity about any one of the X, Y, and Z axes. Therefore, both the S/N ratio and the responsiveness can be maintained with respect to the angular velocity about an axis in an arbitrary direction.

In each of the first embodiment and the modifications (1) to (7) thereof as well as the second embodiment and the modifications (1) and (2) thereof, the monitor electrodes 13h, 13h are disposed at the identical positions or in the identical regions. However, the embodiments of the present invention are not limited to such a case. When N is a natural number of 2 or more or a natural number of 3 or more, and M is equal to 0, 1, . . . , N−1 (hereinafter, always true in this paragraph), in a case where one of the driving electrodes 13a is referred to as a reference driving electrode, the monitor electrodes 13h are not necessarily disposed [(360/N)×{M+(½)}]° apart from the reference driving electrode 13a in the circumferential direction. For example, in a vibration mode of cos Nθ, when L is equal to 0, 1, . . . , 2N−1 (hereinafter, always true in this paragraph), the monitor electrodes 13h are disposed so as not to be (180/N)×{L+(½)}° apart from the reference driving electrode in the circumferential direction, or are disposed so as not to be axisymmetrical with respect to the above angular positions. Moreover, the respective monitor electrodes 13h are disposed so as not to be symmetrical with respect to the center line in the width direction of the ring. Because of the disposition of the respective monitor electrodes 13h, the effects of the first embodiment or any one of the modifications thereof are substantially exerted.

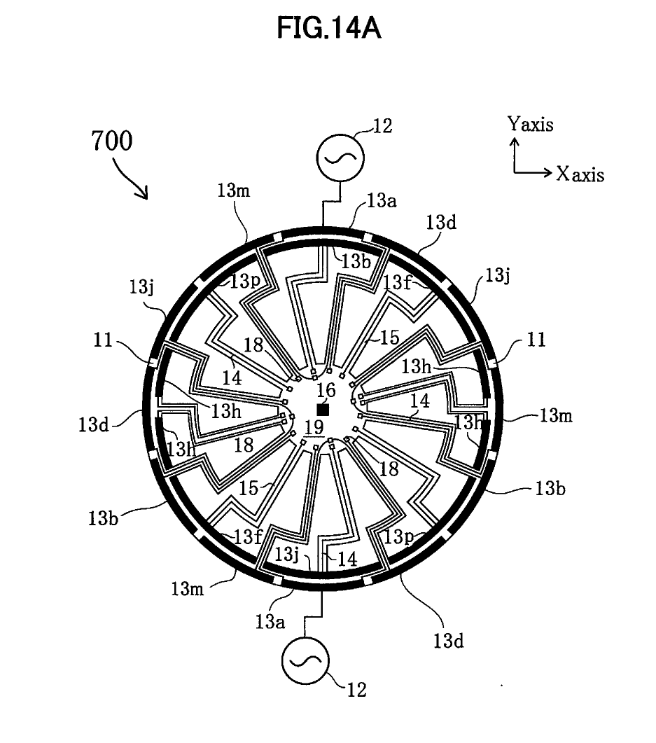

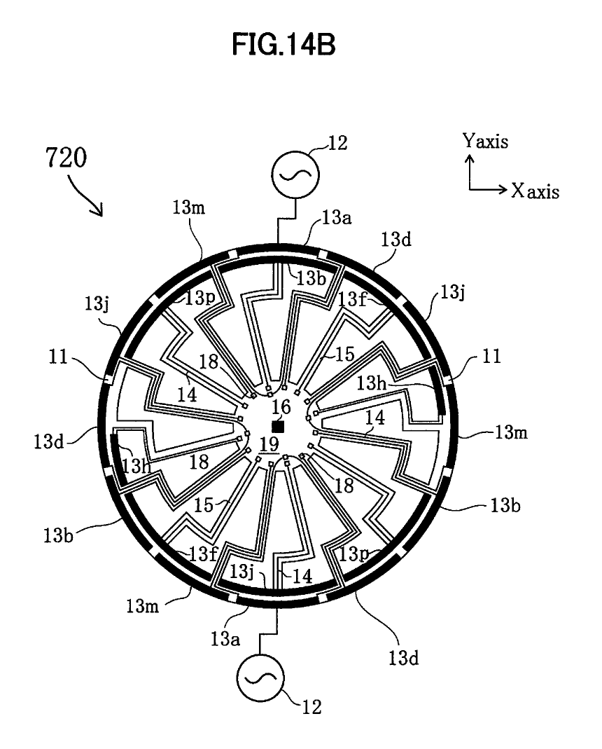

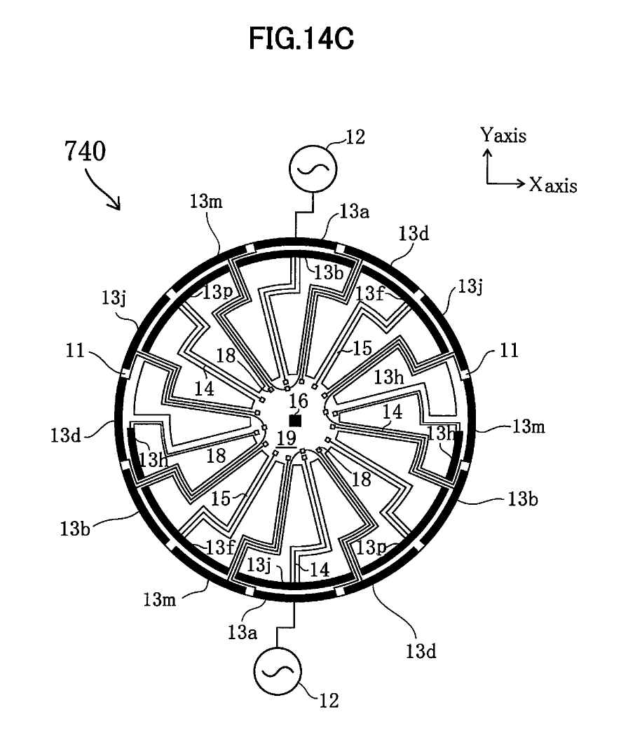

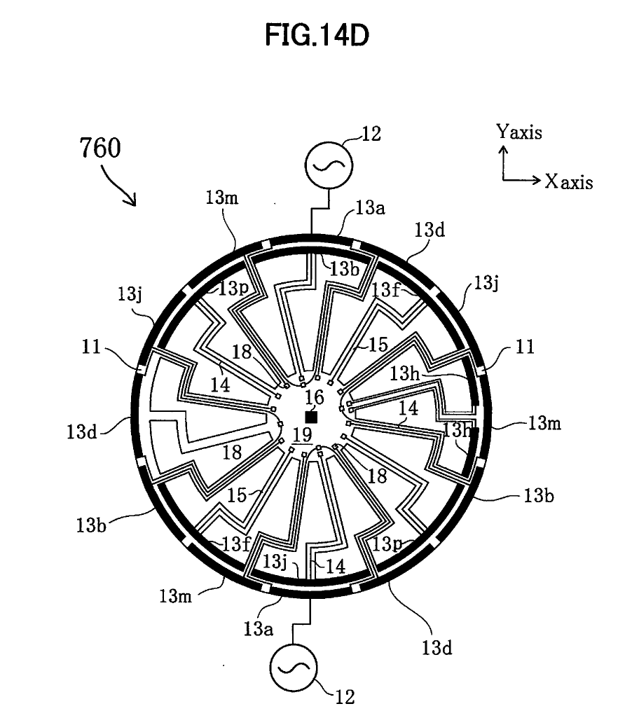

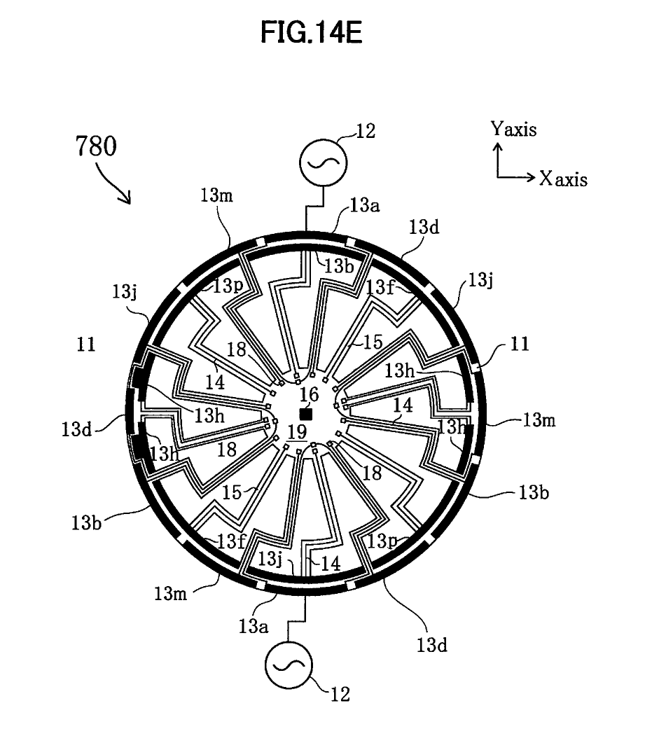

One specific example of the above case is a ring-shaped vibrating gyroscope 700 shown in FIG. 14A. When N is a natural number of 2 or more or a natural number of 3 or more and M is equal to 0, 1, . . . , N−1 (hereinafter, always true in this paragraph), in a case where one of the driving electrodes 13a is referred to as a reference driving electrode, the monitor electrodes 13h, . . . , 13h of the ring-shaped vibrating gyroscope 700 are not necessarily disposed [(360/N)×{M+(½)}]° apart from the reference driving electrode 13a in the circumferential direction. However, effects similar to those of the first embodiment are exerted even with the disposition of the monitor electrodes 13h, . . . , 13h shown in FIG. 14A.

Another example of the above case is a ring-shaped vibrating gyroscope 720 shown in FIG. 14B. In the ring-shaped vibrating gyroscope 720, the monitor electrodes 13h, 13h are disposed such that two out of the monitor electrodes 13h, . . . , 13h are removed from the ring-shaped vibrating gyroscope 700 shown in FIG. 14A. However, effects similar to those of the first embodiment are exerted even with the disposition of the monitor electrodes 13h, 13h shown in FIG. 14B.

Still another example of the above case is a ring-shaped vibrating gyroscope 740 shown in FIG. 14C. In the ring-shaped vibrating gyroscope 740, the monitor electrodes 13h, 13h are disposed such that the remaining two out of the monitor electrodes 13h, . . . , 13h are removed from the ring-shaped vibrating gyroscope 700 shown in FIG. 14A. However, effects similar to those of the first embodiment are exerted even with the disposition of the monitor electrodes 13h, 13h shown in FIG. 14C.

Further, a different example of the above case is a ring-shaped vibrating gyroscope 760 shown in FIG. 14D. In the ring-shaped vibrating gyroscope 760, the monitor electrodes 13h, 13h are disposed such that two different from the above examples out of the monitor electrodes 13h, . . . , 13h are removed from the ring-shaped vibrating gyroscope 700 shown in FIG. 14A. However, effects similar to those of the first embodiment are exerted even with the disposition of the monitor electrodes 13h, 13h shown in FIG. 14D.

Moreover, a different example of the above case is a ring-shaped vibrating gyroscope 780 shown in FIG. 14E. Some of the monitor electrodes 13h, . . . , 13h of the ring-shaped vibrating gyroscope 780 are disposed in the region from the inner peripheral edge to the center line of the ring-shaped vibrating body 11. Each of the second detection electrodes 13d occupies a smaller area. However, the effects of the first embodiment are at least partially exerted even with the disposition of the monitor electrodes 13h, . . . , 13h shown in FIG. 14E. In this case, in view of the symmetrical disposition of the monitor electrodes 13h, the ring-shaped vibrating gyroscope 100 of the first embodiment is more preferred in comparison to the ring-shaped vibrating gyroscope 760 shown in FIG. 14E. Similarly, even in a case where some or all of the monitor electrodes 13h, . . . , 13h are disposed in the region from the outer peripheral edge to the center line of the ring-shaped vibrating body 11 so as not to be symmetrical with respect to the center line, there are exerted effects similar to those of the first embodiment.

As shown in each of the examples described above, in any one of the ring-shaped vibrating gyroscopes according to the present invention, excited is a primary vibration in the in-plane vibration mode. Thus, the monitor electrodes may be disposed on the plane of the ring-shaped vibrating body 11 with a high degree of flexibility. However, for example, in a vibration mode of cos Nθ, when L is equal to 0, 1, . . . , 2N−1 (hereinafter, always true in this paragraph), the respective monitor electrodes 13h are disposed so as not to be (180/N)×{L+(½)}° apart from the reference driving electrode in the circumferential direction, or are disposed so as not to be axisymmetrical with respect to the above angular positions. The monitor electrodes are not disposed at such former positions since deformation of the ring-shaped vibrating body 11 is eliminated (zero) at the former positions. The monitor electrodes are not disposed at such latter positions since the electrodes are deformed in directions opposite to each other so as to cancel the deformations each other. Moreover, the respective monitor electrodes 13h are disposed so as not to be symmetrical with respect to the center line. The monitor electrodes are not disposed at such positions since the monitor electrodes are deformed in directions opposite to each other so as to cancel the deformations each other at the positions. In a limited planar region of the ring-shaped vibrating body 11 that is particularly reduced in size, the disposition of the monitor electrodes 13h as in the first embodiment will facilitate the disposition of the other electrode groups and/or the metal tracks. More specifically, when N is a natural number of 2 or more or a natural number of 3 or more and M is equal to 0, 1, . . . , N−1 (hereinafter, always true in this paragraph), in a case where one of the driving electrodes 13a is referred to as a reference driving electrode, it is a preferred aspect to dispose the monitor electrodes 13h so as to be [(360/N)×{M+(½)}]° apart from the reference driving electrode 13a in the circumferential direction.

### Third Embodiment

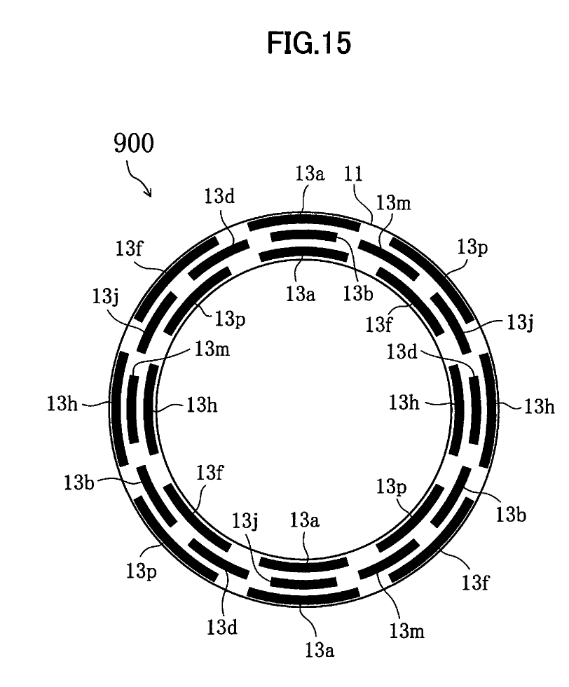

Described with reference to FIGS. 15 to 18 is a third embodiment, which is more preferred rather than the first embodiment described earlier. FIG. 15 is a front view of a structure having a principal function in a ring-shaped vibrating gyroscope 900 according to the present embodiment, for measuring a triaxial angular velocity.

In the ring-shaped vibrating body 11 of the ring-shaped vibrating gyroscope 900, the electrodes are disposed also in the planar region including the center line. In the annular portion of the ring-shaped vibrating body, the electrodes are disposed in three regions, namely, the region from the inner peripheral edge to the vicinity of the inner peripheral edge, the region including the center line, and the region from the outer peripheral edge to the vicinity of the outer peripheral edge. In this ring-shaped vibrating gyroscope 900, suppressed is a secondary vibration generated by an angular velocity about every one of the X, Y, and Z axes.

In the disposition described above, the driving electrodes 13a, the monitor electrodes 13h, the third detection electrodes 13f, and the third suppression electrodes 13p, which are related to an in-plane vibration (an exited vibration, that is, a secondary vibration generated by an angular velocity about the Z axis), can be disposed in the region from the inner peripheral edge to the vicinity of the inner peripheral edge and the region from the outer peripheral edge to the vicinity of the outer peripheral edge. On the other hand, the first and second detection electrodes 13b, 13d, and the first and second suppression electrodes 13j, 13m, which are related to an out-of-plane vibration (a secondary vibration generated by an angular velocity about each of the X and Y axes), can be disposed in the region including the center line. Therefore, in the ring-shaped vibrating gyroscope 900 shown in FIG. 15, drive signals, detection signals, and suppression signals are unlikely to be relevant to an unintended vibration, namely, either an in-plane vibration or an out-of-plane vibration. Therefore, this case is a preferred aspect of the present invention.

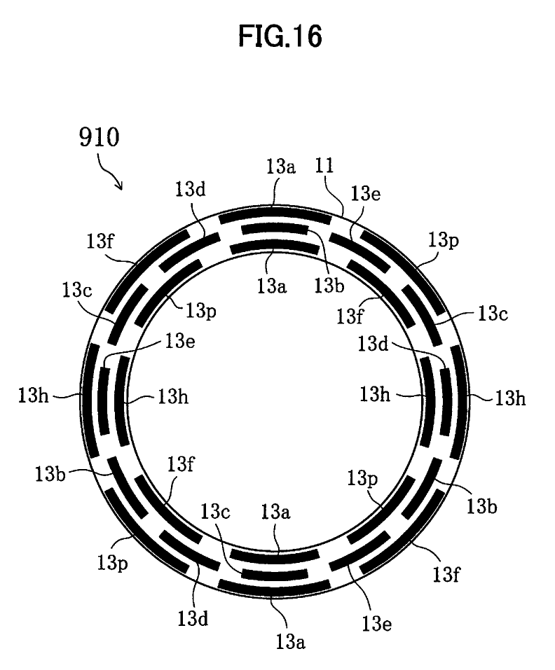

FIG. 16 shows disposition of electrodes in a ring-shaped vibrating gyroscope 910 according to a modification, which is obtained by modifying the ring-shaped vibrating gyroscope 900 so as to apply the suppression of a secondary vibration only to an angular velocity about the Z axis. Also in this case, similarly to the above, drive signals, detection signals, and suppression signals are unlikely to be relevant to an unintended vibration, namely, either an in-plane vibration or an out-of-plane vibration. Therefore, this case is a preferred aspect of the present invention.

FIG. 17 shows disposition of electrodes in a ring-shaped vibrating gyroscope 920 according to another modification, which is obtained by modifying the ring-shaped vibrating gyroscope 900 so as to apply, only to an angular velocity about a Z axis, the suppression of a secondary vibration modified to improve accuracy of the detection of the angular velocity about the Z axis. This ring-shaped vibrating gyroscope 920 includes the detection electrodes 13g as third detection electrodes in addition to the detection electrodes 13f, as well as includes suppression electrodes 13q as third suppression electrodes in addition to the detection electrodes 13p. Upon detection of an angular velocity about the Z axis, electrical signals of positive and negative polarities can be obtained by the third detection electrodes 13f, 13g. Accordingly, the detection can be made with a high degree of accuracy by a known difference circuit (not shown) which is connected to these detection electrodes. Further, in order to suppress a secondary vibration generated by an angular velocity about the Z axis, the third suppression electrodes 13p, 13q operate to exert driving forces for suppressing the ring-shaped vibrating body 11 from both the vicinity of the inner peripheral edge and the vicinity of the outer peripheral edge. Therefore, both the S/N ratio and the responsiveness can be maintained more preferably.

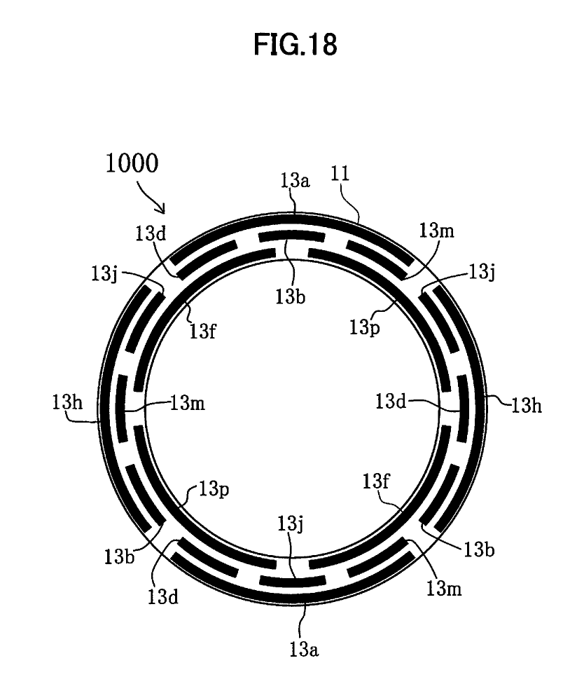

FIG. 18 shows still another modification. Electrodes in a ring-shaped vibrating gyroscope 1000 shown in this figure are disposed differently from the ring-shaped vibrating gyroscope 900, in the region from the inner peripheral edge to the vicinity of the inner peripheral edge and the region from the outer peripheral edge to the vicinity of the outer peripheral edge. More specifically, the electrodes related to a primary vibration, namely, the driving electrodes 13a and the monitor electrodes 13h, are disposed in the region from the outer peripheral edge to the vicinity of the outer peripheral edge. The electrodes related to a secondary vibration generated by an angular velocity about the Z axis, namely, the third detection electrodes 13f and the third suppression electrodes 13p, are disposed in the region from the inner peripheral edge to the vicinity of the inner peripheral edge.

Such disposition allows the electrodes to be expanded, in other words, expands the lengths of the electrodes in the angular direction. Therefore, a primary vibration can be exited easily, and a secondary vibration generated by an angular velocity about the Z axis can be detected and suppressed easily. Therefore, both the S/N ratio and the responsiveness are advantageously maintained at high levels in the detection of an angular velocity about each of the X and Y axes, as well as the detection of an angular velocity about the Z axis.

### Other Modifications

Applicable to the second embodiment are respective modifications similarly to those of the first embodiment as described above. Therefore, there are exerted advantageous effects in accordance with the respective configurations thereof.

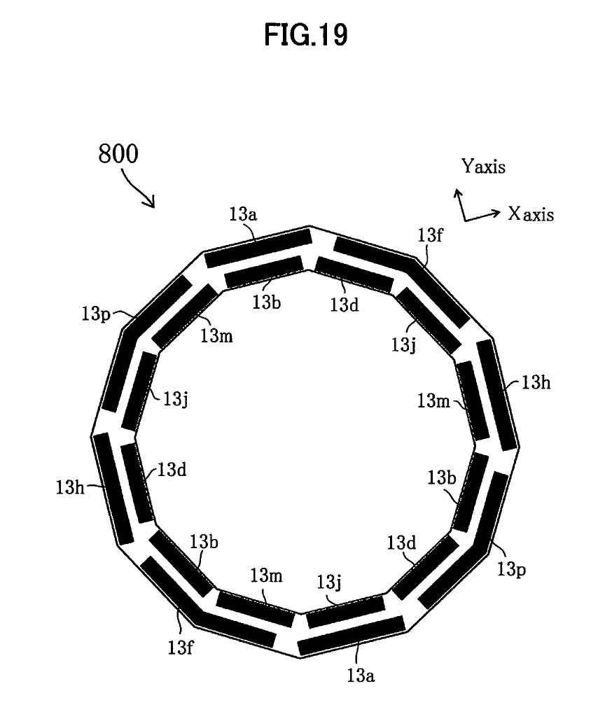

Each of the embodiments described above refers to the vibrating gyroscope including the ring-shaped vibrating body. However, the ring-shaped vibrating body may be replaced with a polygonal vibrating body. There are exerted effects substantially similar to those of the present invention even with use of a vibrating body in a regular polygonal shape such as a regular hexagonal shape, a regular octagonal shape, a regular dodecagonal shape, or a regular icosagonal shape. Further alternatively, there may be adopted a vibrating body such as a dodecagonal vibrating body 111 of a ring-shaped vibrating gyroscope 800 shown in FIG. 19. In view of stability of the vibrating body during the vibration motions, it is preferred to adopt a ring-shaped vibrating body that has an outer peripheral edge or an inner peripheral edge in a polygonal shape being symmetrical with respect to a point or in a polygonal shape of n-fold symmetry (n is an arbitrary natural number) in a front view of the vibrating body. It is noted that the “ring shape” is inclusive of an elliptical shape. Unlike FIG. 1 and other figures, the leg portions and the post are not illustrated in FIG. 19 for easier comprehension of the figure.

Moreover, adopted in each of the embodiments described above is the ring-shaped vibrating gyroscope that is mainly made of silicon. However, the present invention is not limited to such a case. Alternatively, the base material for the vibrating gyroscope may be germanium or silicon germanium, for example. By particularly adopting silicon or silicon germanium among the above materials, it is possible to apply the known anisotropic dry etching technique, which leads to significant contribution to the improvement in processing accuracy of the entire gyroscope including the vibrating body.

In each of the embodiments described above, the upper-layer metallic film is patterned to form the respective electrodes. However, the present invention is not limited to this case. There will be exerted effects similar to those of the present invention even in a case where only the lower-layer metallic film, or both the upper-layer metallic film and the lower-layer metallic film, are patterned to form the respective electrodes. Nevertheless, in view of the facilitation in the manufacturing steps, it is a preferred aspect to pattern only the upper-layer metallic film as in each of the embodiments described above. As having been described so far, modifications made within the scope of the present invention, inclusive of other combinations of the respective embodiments, will be also included in the scope of the patent claims.

### INDUSTRIAL APPLICABILITY

The present invention is applicable, as a vibrating gyroscope, to portions of various types of devices.

1. A vibrating gyroscope comprising:
a ring-shaped vibrating body having a uniform plane;
leg portions flexibly supporting the ring-shaped vibrating body;
a plurality of electrodes disposed on the plane of or above the ring-shaped vibrating body, and formed with at least one of an upper-layer metallic film and a lower-layer metallic film; and
a piezoelectric film being sandwiched between the upper-layer metallic film and the lower-layer metallic film in a thickness direction thereof; wherein
the plurality of electrodes include
(1) when N is a natural number of 2 or more, driving electrodes for exciting a primary vibration of the ring-shaped vibrating body in a vibration mode of cos Nθ, the driving electrodes being disposed (360/N)° apart from each other in a circumferential direction,
(2) detection electrodes for detecting a secondary vibration in a vibration mode of cos(N+1)θ generated when an angular velocity is applied to the ring-shaped vibrating body, and, when one of the driving electrodes is referred to as a reference driving electrode and S is equal to 0, 1, . . . , N, the detection electrodes being disposed at least any of [{360/(N+1)}×S]° apart from the reference driving electrode and [{360/(N+1)}×{S+(½)}]° apart from the reference driving electrode, and
(3) suppression electrodes for suppressing the secondary vibration in accordance with signals outputted from the detection electrodes, the suppression electrodes being disposed at least any of [{360/(N+1)}×S]° apart from the reference driving electrode and [{360/(N+1)}×{S+(½)}]° apart from the reference driving electrode;
the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge;
the detection electrodes and the suppression electrodes are each disposed on a second electrode disposition portion and are not electrically connected to any one of the driving electrodes; and
some of the leg portions are provided thereon with metal tracks that are each electrically connected to corresponding one of the driving electrodes, the detection electrodes, and the suppression electrodes.

2. A vibrating gyroscope comprising:
a ring-shaped vibrating body having a uniform plane;
leg portions flexibly supporting the ring-shaped vibrating body;
a plurality of electrodes disposed on the plane of or above the ring-shaped vibrating body, and formed with at least one of an upper-layer metallic film and a lower-layer metallic film; and
a piezoelectric film being sandwiched between the upper-layer metallic film and the lower-layer metallic film in a thickness direction thereof; wherein
the plurality of electrodes include
(1) when N is a natural number of 2 or more, driving electrodes for exciting a primary vibration of the ring-shaped vibrating body in a vibration mode of cos Nθ, the driving electrodes being disposed (360/N)° apart from each other in a circumferential direction,
(2) detection electrodes for detecting a secondary vibration in a vibration mode of cos(N+1)θ generated when an angular velocity is applied to the ring-shaped vibrating body, and, when one of the driving electrodes is referred to as a reference driving electrode and S is equal to 0, 1, . . . , N, the detection electrodes being disposed at least any of [{360/(N+1)}×{S+(¼)}]° apart from the reference driving electrode and [{360/(N+1)}×{S+(¾)}]° apart from the reference driving electrode, and
(3) suppression electrodes for suppressing the secondary vibration in accordance with signals outputted from the detection electrodes, the suppression electrodes being disposed at least any of [{360/(N+1)}×{S+(¼)}]° apart from the reference driving electrode and [{360/(N+1)}×{S+(¾)}]° apart from the reference driving electrode;
the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge;
the detection electrodes and the suppression electrodes are each disposed on a second electrode disposition portion and are not electrically connected to any one of the driving electrodes; and
some of the leg portions are provided thereon with metal tracks that are each electrically connected to corresponding one of the driving electrodes, the detection electrodes, and the suppression electrodes.

3. A vibrating gyroscope comprising:
a ring-shaped vibrating body having a uniform plane;
leg portions flexibly supporting the ring-shaped vibrating body;
a plurality of electrodes disposed on the plane of or above the ring-shaped vibrating body, and formed with at least one of an upper-layer metallic film and a lower-layer metallic film; and
a piezoelectric film being sandwiched between the upper-layer metallic film and the lower-layer metallic film in a thickness direction thereof; wherein
the plurality of electrodes include
(1) when N is a natural number of 2 or more, driving electrodes for exciting a primary vibration of the ring-shaped vibrating body in a vibration mode of cos Nθ, the driving electrodes being disposed (360/N)° apart from each other in a circumferential direction,
(2) first detection electrodes for detecting a first secondary vibration in a vibration mode of cos(N+1)θ generated when an angular velocity is applied to the ring-shaped vibrating body, and, when one of the driving electrodes is referred to as a reference driving electrode and S is equal to 0, 1, . . . , N, the first detection electrodes being disposed at least any of [{360/(N+1)}×S]° apart from the reference driving electrode and [{360/(N+1)}×{S+(½)}]° apart from the reference driving electrode,
(3) second detection electrodes for detecting a second secondary vibration having a vibration axis {90/(N+1)}° apart from that of the first secondary vibration, the second detection electrodes being disposed at least any of [{360/(N+1)}×{S+(¼)}]° apart from the reference driving electrode and [{360/(N+1)}×{S+(¾)}]° apart from the reference driving electrode,
(4) first suppression electrodes for suppressing the first secondary vibration in accordance with signals outputted from the first detection electrodes, the first suppression electrodes being disposed at least any of [{360/(N+1)}×S]° apart from the reference driving electrode and [{360/(N+1)}×{S+(½)}]° apart from the reference driving electrode, and
(5) second suppression electrodes for suppressing the second secondary vibration in accordance with signals outputted from the second detection electrodes, the second suppression electrodes being disposed at least any of [{360/(N+1)}×{S+¼}]° apart from the reference driving electrode and [{360/(N+1)}×{S+(¾)}]° apart from the reference driving electrode;
the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge;
the first detection electrodes, the second detection electrodes, the first suppression electrodes, and the second suppression electrodes are each disposed on a second electrode disposition portion and are not electrically connected to any one of the driving electrodes; and
some of the leg portions are provided thereon with metal tracks that are each electrically connected to corresponding one of the driving electrodes, the first detection electrodes, the second detection electrodes, the first suppression electrodes, and the second suppression electrodes.

4. The vibrating gyroscope according to claim 1, wherein
when the detection electrodes, the suppression electrodes, and the secondary vibration are referred to as first detection electrodes, first suppression electrodes, and a first secondary vibration, respectively, the plurality of electrodes further include
(4) second detection electrodes for detecting a second secondary vibration having a vibration axis {90/(N+1)}° apart from that of the first secondary vibration, the second detection electrodes being disposed at least any of [{360/(N+1)}×{S+(¼)}]° apart from the reference driving electrode and [{360/(N+1)}×{S+(¾)}]° apart from the reference driving electrode, and
the second detection electrodes are each disposed on the second electrode disposition portion.

5. The vibrating gyroscope according to claim 2, wherein
when the detection electrodes, the suppression electrodes, and the secondary vibration are referred to as second detection electrodes, second suppression electrodes, and a second secondary vibration, respectively, the plurality of electrodes further include
(4) first detection electrodes for detecting a first secondary vibration having a vibration axis {90/(N+1)}° apart from that of the second secondary vibration, the first detection electrodes being disposed at least any of [{360/(N+1)}×S]° apart from the reference driving electrode and [{360/(N+1)}×{S+(½)}]° apart from the reference driving electrode, and
the first detection electrodes are each disposed on the second electrode disposition portion.

6. A vibrating gyroscope comprising:
a ring-shaped vibrating body having a uniform plane;
leg portions flexibly supporting the ring-shaped vibrating body;
a plurality of electrodes disposed on the plane of or above the ring-shaped vibrating body, and formed with at least one of an upper-layer metallic film and a lower-layer metallic film; and
a piezoelectric film being sandwiched between the upper-layer metallic film and the lower-layer metallic film in a thickness direction thereof; wherein
the plurality of electrodes include
(1) when N is a natural number of 3 or more, driving electrodes for exciting a primary vibration of the ring-shaped vibrating body in a vibration mode of cos Nθ, the driving electrodes being disposed (360/N)° apart from each other in a circumferential direction,
(2) detection electrodes for detecting a secondary vibration in a vibration mode of cos(N−1)θ generated when an angular velocity is applied to the ring-shaped vibrating body, and, when one of the driving electrodes is referred to as a reference driving electrode and S is equal to 0, 1, . . . , N−2, the detection electrodes being disposed at least any of [{360/(N−1)}×S]° apart from the reference driving electrode and [{360/(N−1)}×{S+(½)}]° apart from the reference driving electrode, and
(3) suppression electrodes for suppressing the secondary vibration in accordance with signals outputted from the detection electrodes, the suppression electrodes being disposed at least any of [{360/(N−1)}×S]° apart from the reference driving electrode and [{360/(N−1)}×{S+(½)}]° apart from the reference driving electrode;
the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge;
the detection electrodes and the suppression electrodes are each disposed on a second electrode disposition portion and are not electrically connected to the first electrode disposition portion; and
some of the leg portions are provided thereon with metal tracks that are each electrically connected to corresponding one of the driving electrodes, the detection electrodes, and the suppression electrodes.

7. A vibrating gyroscope comprising:
a ring-shaped vibrating body having a uniform plane;
leg portions flexibly supporting the ring-shaped vibrating body;
a plurality of electrodes disposed on the plane of or above the ring-shaped vibrating body, and formed with at least one of an upper-layer metallic film and a lower-layer metallic film; and
a piezoelectric film being sandwiched between the upper-layer metallic film and the lower-layer metallic film in a thickness direction thereof; wherein
the plurality of electrodes include
(1) when N is a natural number of 3 or more, driving electrodes for exciting a primary vibration of the ring-shaped vibrating body in a vibration mode of cos Nθ, the driving electrodes being disposed (360/N)° apart from each other in a circumferential direction,
(2) detection electrodes for detecting a secondary vibration in a vibration mode of cos(N−1)θ generated when an angular velocity is applied to the ring-shaped vibrating body, and, when one of the driving electrodes is referred to as a reference driving electrode and S is equal to 0, 1, . . . , N−2, the detection electrodes being disposed at least any of [{360/(N−1)}×{S+(¼)}]° apart from the reference driving electrode and [{360/(N−1)}×{S+(¾)}]° apart from the reference driving electrode, and
(3) suppression electrodes for suppressing the secondary vibration in accordance with signals outputted from the detection electrodes, the suppression electrodes being disposed at least any of [{360/(N−1)}×{S+(¼)}]° apart from the reference driving electrode and [{360/(N−1)}×{S+(¾)}]° apart from the reference driving electrode;
the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge;
the detection electrodes and the suppression electrodes are each disposed on a second electrode disposition portion and are not electrically connected to the first electrode disposition portion; and
some of the leg portions are provided thereon with metal tracks that are each electrically connected to corresponding one of the driving electrodes, the detection electrodes, and the suppression electrodes.

8. A vibrating gyroscope comprising:
a ring-shaped vibrating body having a uniform plane;
leg portions flexibly supporting the ring-shaped vibrating body;
a plurality of electrodes disposed on the plane of or above the ring-shaped vibrating body, and formed with at least one of an upper-layer metallic film and a lower-layer metallic film; and
a piezoelectric film being sandwiched between the upper-layer metallic film and the lower-layer metallic film in a thickness direction thereof; wherein
the plurality of electrodes include
(1) when N is a natural number of 3 or more, driving electrodes for exciting a primary vibration of the ring-shaped vibrating body in a vibration mode of cos Nθ, the driving electrodes being disposed (360/N)° apart from each other in a circumferential direction,
(2) first detection electrodes for detecting a first secondary vibration in a vibration mode of cos(N−1)θ generated when an angular velocity is applied to the ring-shaped vibrating body, and, when one of the driving electrodes is referred to as a reference driving electrode and S is equal to 0, 1, . . . , N−2, the first detection electrodes being disposed at least any of [{360/(N−1)}×S]° apart from the reference driving electrode and [{360/(N−1)}×{S+(½)}]° apart from the reference driving electrode,
(3) second detection electrodes for detecting a second secondary vibration having a vibration axis {90/(N−1)}° apart from that of the first secondary vibration, the second detection electrodes being disposed at least any of [{360/(N−1)}×{S+(¼)}]° apart from the reference driving electrode and [{360/(N−1)}×{S+(¾)}]° apart from the reference driving electrode,
(4) first suppression electrodes for suppressing the first secondary vibration in accordance with signals outputted from the first detection electrodes, the first suppression electrodes being disposed at least any of [{360/(N−1)}×S]° apart from the reference driving electrode and [{360/(N−1)}×{S+(½)}]° apart from the reference driving electrode, and
(5) second suppression electrodes for suppressing the second secondary vibration in accordance with signals outputted from the second detection electrodes, the second suppression electrodes being disposed at least any of [{360/(N−1)}×{S+¼}]° apart from the reference driving electrode and [{360/(N−1)}×{S+(¾)}]° apart from the reference driving electrode;
the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge;
the first detection electrodes, the second detection electrodes, the first suppression electrodes, and the second suppression electrodes are each disposed on a second electrode disposition portion and are not electrically connected to the first electrode disposition portion; and
some of the leg portions are provided thereon with metal tracks that are each electrically connected to corresponding one of the driving electrodes, the first detection electrodes, the second detection electrodes, the first suppression electrodes, and the second suppression electrodes.

9. The vibrating gyroscope according to claim 6, wherein
when the detection electrodes, the suppression electrodes, and the secondary vibration are referred to as first detection electrodes, first suppression electrodes, and a first secondary vibration, respectively, the plurality of electrodes further include
(4) second detection electrodes for detecting a second secondary vibration having a vibration axis {90/(N−1)}° apart from that of the first secondary vibration, the second detection electrodes being disposed at least any of [{360/(N−1)}×{S+(¼)}]° apart from the reference driving electrode and [{360/(N−1)}×{S+(¾)}]° apart from the reference driving electrode, and
the second detection electrodes are each disposed on the second electrode disposition portion.

10. The vibrating gyroscope according to claim 7, wherein
when the detection electrodes, the suppression electrodes, and the secondary vibration are referred to as second detection electrodes, second suppression electrodes, and a second secondary vibration, respectively, the plurality of electrodes further include
(4) first detection electrodes for detecting a first secondary vibration having a vibration axis {90/(N−1)}° apart from that of the second secondary vibration, the first detection electrodes being disposed at least any of [{360/(N−1)}×S]° apart from the reference driving electrode and [{360/(N−1)}×{S+(½)}]° apart from the reference driving electrode, and
the first detection electrodes are each disposed on the second electrode disposition portion.

11. The vibrating gyroscope according to any one of claims 1 to 3, and 6 to 8, wherein
the plurality of electrodes further include
(6) third detection electrodes for detecting a third secondary vibration in a vibration mode of cos Nθ generated when an angular velocity is applied to the ring-shaped vibrating body, and, when M is equal to 0, 1, . . . , N−1, the third detection electrodes being disposed at least any of [(360/N)×{M+(¼)}]° apart from the reference driving electrode and [(360/N)×{M+(¾)}]° apart from the reference driving electrode, and
the third detection electrodes are each disposed on the first electrode disposition portion.

12. The vibrating gyroscope according to claim 11, wherein
the plurality of electrodes further include
(7) third suppression electrodes for suppressing the third secondary vibration in accordance with signals outputted from the third detection electrodes, and, when M is equal to 0, 1, . . . , N−1, the third suppression electrodes being disposed at least any of [(360/N)×{M+(¼)}]° apart from the reference driving electrode and [(360/N)×{M+(¾)}]° apart from the reference driving electrode, and
the third suppression electrodes are each disposed on the first electrode disposition portion.

13. A vibrating gyroscope comprising:
a ring-shaped vibrating body having a uniform plane;
leg portions flexibly supporting the ring-shaped vibrating body;
a plurality of electrodes disposed on the plane of or above the ring-shaped vibrating body, and formed with at least one of an upper-layer metallic film and a lower-layer metallic film; and
a piezoelectric film being sandwiched between the upper-layer metallic film and the lower-layer metallic film in a thickness direction thereof; wherein
the plurality of electrodes include
(1) when N is a natural number of 2 or more, driving electrodes for exciting a primary vibration of the ring-shaped vibrating body in a vibration mode of cos Nθ, the driving electrodes being disposed (360/N)° apart from each other in a circumferential direction;
the plurality of electrodes include at least any of
(2) first detection electrodes for detecting a first secondary vibration in a vibration mode of cos(N+1)θ generated when an angular velocity is applied to the ring-shaped vibrating body, and, when one of the driving electrodes is referred to as a reference driving electrode and S is equal to 0, 1, . . . , N, the first detection electrodes being disposed at least any of [{360/(N+1)}×S]° apart from the reference driving electrode and [{360/(N+1)}×{S+(½)}]° apart from the reference driving electrode, and
(3) second detection electrodes different from the first detection electrodes, the second detection electrodes for detecting a second secondary vibration which has a vibration axis {90/(N+1)}° apart from that of the first secondary vibration, is in a vibration mode of cos(N+1)θ, and is generated when an angular velocity is applied to the ring-shaped vibrating body, the second detection electrodes being disposed at least any of [{360/(N+1)}×{S+(¼)}]° apart from the reference driving electrode and [{360/(N+1)}×{S+(¾)}]° apart from the reference driving electrode;
the plurality of electrodes include
(4) third detection electrodes for detecting a third secondary vibration which has a vibration axis (90/N)° apart from that of the primary vibration, is in a vibration mode of cos Nθ, and is generated when an angular velocity is applied to the ring-shaped vibrating body, and, when M is equal to 0, 1, . . . , N−1, the third detection electrodes being disposed at least any of [(360/N)×{M+(¼)}]° apart from the reference driving electrode and [(360/N)×{M+(¾)}]° apart from the reference driving electrode, and
(5) suppression electrodes for suppressing the secondary vibration in accordance with signals outputted from the third detection electrodes, and, when M is equal to 0, 1, . . . , N−1, the suppression electrodes being disposed at least any of [(360/N)×{M+(¼)}]° apart from the reference driving electrode and [(360/N)×{M+(¾)}]° apart from the reference driving electrode;
the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge;
the first detection electrodes and the second detection electrodes are each disposed on a second electrode disposition portion and are not electrically connected to any one of the driving electrodes;
the third detection electrodes and the suppression electrodes are each disposed on the first electrode disposition portion and are not electrically connected to any one of the driving electrodes; and
some of the leg portions are provided thereon with metal tracks that are each electrically connected to corresponding one of the driving electrodes, the first detection electrodes, the second detection electrodes, the third detection electrodes, and the suppression electrodes.

14. A vibrating gyroscope comprising:
a ring-shaped vibrating body having a uniform plane;
leg portions flexibly supporting the ring-shaped vibrating body;
a plurality of electrodes disposed on the plane of or above the ring-shaped vibrating body, and formed with at least one of an upper-layer metallic film and a lower-layer metallic film; and
a piezoelectric film being sandwiched between the upper-layer metallic film and the lower-layer metallic film in a thickness direction thereof; wherein
the plurality of electrodes include
(1) when N is a natural number of 3 or more, driving electrodes for exciting a primary vibration of the ring-shaped vibrating body in a vibration mode of cos Nθ, the driving electrodes being disposed (360/N)° apart from each other in a circumferential direction;
the plurality of electrodes include at least any of
(2) first detection electrodes for detecting a first secondary vibration in a vibration mode of cos(N−1)θ generated when an angular velocity is applied to the ring-shaped vibrating body, and, when one of the driving electrodes is referred to as a reference driving electrode and S is equal to 0, 1, . . . , N−2, the first detection electrodes being disposed at least any of [{360/(N−1)}×S]° apart from the reference driving electrode and [{360/(N−1)}×{S+(½)}]° apart from the reference driving electrode, and
(3) second detection electrodes different from the first detection electrodes, the second detection electrodes for detecting a second secondary vibration which has a vibration axis {90/(N−1)}° apart from that of the first secondary vibration, is in a vibration mode of cos(N−1)θ, and is generated when an angular velocity is applied to the ring-shaped vibrating body, the second detection electrodes being disposed at least any of [{360/(N−1)}×{S+(¼)}]° apart from the reference driving electrode and [{360/(N−1)}×{S+(¾)}]° apart from the reference driving electrode;
the plurality of electrodes include
(4) third detection electrodes for detecting a third secondary vibration which has a vibration axis (90/N)° apart from that of the primary vibration, is in a vibration mode of cos Nθ, and is generated when an angular velocity is applied to the ring-shaped vibrating body, and, when M is equal to 0, 1, . . . , N−1, the third detection electrodes being disposed at least any of [(360/N)×{M+(¼)}]° apart from the reference driving electrode and [(360/N)×{M+(¾)}]° apart from the reference driving electrode, and
(5) suppression electrodes for suppressing the secondary vibration in accordance with signals outputted from the third detection electrodes, and, when M is equal to 0, 1, . . . , N−1, the suppression electrodes being disposed at least any of [(360/N)×{M+(¼)}]° apart from the reference driving electrode and [(360/N)×{M+(¾)}]° apart from the reference driving electrode;
the driving electrodes are each disposed in the plane of the ring-shaped vibrating body and on a first electrode disposition portion that has at least one of a region from an outer peripheral edge of the ring-shaped vibrating body to a vicinity of the outer peripheral edge and a region from an inner peripheral edge thereof to a vicinity of the inner peripheral edge;
the first detection electrodes and the second detection electrodes are each disposed on a second electrode disposition portion and are not electrically connected to any one of the driving electrodes;
the third detection electrodes and the suppression electrodes are each disposed on the first electrode disposition portion and are not electrically connected to any one of the driving electrodes; and
some of the leg portions are provided thereon with metal tracks that are each electrically connected to corresponding one of the driving electrodes, the first detection electrodes, the second detection electrodes, the third detection electrodes, and the suppression electrodes.

15. The vibrating gyroscope according to any one of claims 1 to 3, 6 to 8, 13, and 14, wherein
the plurality of electrodes further include
(8) when L is equal to 0, 1, . . . , 2N−1, a group of monitor electrodes disposed so as not to be (180/N)×{L+(½)}° apart from the reference driving electrode in the circumferential direction.

16. The vibrating gyroscope according to any one of claims 1 to 3, 6 to 8, 13, and 14, wherein
the plurality of electrodes further include
(8) when M is equal to 0, 1, . . . , N−1, monitor electrodes disposed [(360/N)×{M+(½)}]° apart from the reference driving electrode in the circumferential direction.

17. The vibrating gyroscope according to any one of claims 1 to 3, 6 to 8, 13, and 14, wherein
the second electrode disposition portion includes a center line connecting centers in a width direction from the outer peripheral edge to the inner peripheral edge.

18. The vibrating gyroscope according to any one of claims 1 to 3, 6 to 8, 13, and 14, wherein
the ring-shaped vibrating body is formed with a silicon substrate, and
only the upper-layer metallic film, the piezoelectric film, and the lower-layer metallic film are substantially visible in a front view.

19. The vibrating gyroscope according to any one of claims 1 to 3, 6 to 8, 13, and 14, wherein
the ring-shaped vibrating body is formed with a silicon substrate, and
only the upper-layer metallic film and the lower-layer metallic film are substantially visible in a front view.
